(19) United States
(12) Patent Application Publication
(10) Pub. No.: US 2026/0246782 A1
(43) Pub. Date: Aug. 20, 2026

(54) SYSTEMS AND METHODS FOR MULTI-LAYER SECURE AUTHENTICATION ENGINE FOR DIGITAL NETWORK SECURITY

(71) Applicant: BANK OF AMERICA CORPORATION, Charlotte, NC (US)

(72) Inventors: Laxma Gavinolla, Hyderabad (IN); Meenu Goyal, Moga (IN); Durga Prasad Kutthumolu, Hyderabad (IN); Pinky Panwar, Gandhidham (IN)

(73) Assignee: BANK OF AMERICA CORPORATION, Charlotte, NC (US)

(21) Appl. No.: 19/058,904

(22) Filed: Feb. 20, 2025

(51) Int. Cl. H04L 9/40

(52) U.S. Cl. CPC H04L 63/105

(57) ABSTRACT

Systems, computer program products, and methods are described herein for multi-layer secure authentication engine for digital network security. The present disclosure is configured to receive and extract network data from one or more digital network requests and determine one or more network accounts associated with a first user based on the network data. In addition, the present disclosure is configured to identify a network validation domain based on the network data, as well as transmit, via a first network node agent, the network data and the network validation domain to a multi-layer secure authentication (MLSA) engine. Furthermore, the present disclosure is configured to execute, via the MLSA engine, a first authentication protocol and transmit the network data to a second network node agent. The MLSA engine also executes a second authentication protocol.

### TECHNOLOGICAL FIELD

Example embodiments of the present disclosure relate to multi-layer secure authentication engine for digital network security.

### BACKGROUND

Effective, dynamic, and secure management of cross-distributed ledger network transmissions is necessary due to an increase in the number of distributed ledger platforms. Cross-distributed ledger network transmissions comprise network transactions occurring across unassociated distributed ledgers. Facilitating cross-distributed ledger network transmissions allows for seamless, efficient transactions across heterogenous distributed ledgers. However, security of seamless transactions across unassociated distributed ledgers may be compromised without requisite security criteria and validations. Frequently, cross-distributed ledger network transmissions rely on complex pre-verifications, which result in network latencies and degraded performance, or third party trust assumptions. Third party trust assumptions involve heightened security vulnerabilities, such as token hijacking and leveraging compromised encrypted self-executing programs. When malicious actors utilize token hijacking, they may lock tokens associated with digital objects, mint tokens without authorization, and provide consent for executing unauthorized network transmissions. Furthermore, malicious actors may harness vulnerabilities in encrypted self-executing programs, such as improper access controls and semantic inconsistencies, to execute malicious actions. As cross-distributed ledger network transmissions increase in frequency and complexity, it is essential to develop methods for an effective multi-layer security authentication engine for digital network security to improve the security, performance, and effectiveness of cross-distributed ledger network transmissions.

Applicant has identified a number of deficiencies and problems associated with multi-layer secure authentication engine for digital network security. Through applied effort, ingenuity, and innovation, many of these identified problems have been solved by developing solutions that are included in embodiments of the present disclosure, many examples of which are described in detail herein.

### BRIEF SUMMARY

Systems, methods, and computer program products are provided for multi-layer secure authentication engine for digital network security.

In one aspect, a system for multi-layer secure authentication engine for digital network security is provided. In some embodiments, the system may comprise a memory device with computer-readable program code stored thereon; at least one processing device, wherein executing the computer-readable program code is configured to cause the at least one processing device to execute the computer-readable program code to: receive and extract network data from one or more digital network requests; determine one or more network accounts associated with a first user based on the network data identify a network validation domain based on the network data; transmit, via a first network node agent, the network data and the network validation domain to a multi-layer secure authentication (MLSA) engine; execute, via the MLSA engine, a first authentication protocol; transmit the network data to a second network node agent; and execute, via the MLSA engine, a second authentication protocol.

In some embodiments, the first authentication protocol comprises: initiating a first encrypted self-executing program; determining, via the first encrypted self-executing program, access control criteria based on at least the network data, wherein the network data comprises a first network node chain, a target network node chain, and network transmission resources; generating one or more network node chain graphs based on at least one of the access control criteria, wherein the one or more network node chain graphs comprise a cross network chain control graph and a network data packet flow graph; and determining a semantic threshold based on the one or more network node chain graphs.

In some embodiments, executing the computer-readable program code is further configured to cause the at least one processing device to: determine a first authentication protocol anomaly based on at least one of the access control criteria, one or more network node chain graphs, and semantic threshold; intercept the one or more digital network requests; and transmit a first authentication protocol anomaly notification to the first network node agent.

In some embodiments, the second authentication protocol comprises: identifying network node validation criteria based on at least the network data, wherein the network data further comprises a second encrypted self-executing program dataset and a first encrypted self-executing program dataset; and executing a network node validation based on at least the network validation domain, wherein the network node validation comprises a relay network validation from each network node in at least one network node chain.

In some embodiments, executing the computer-readable program code is further configured to cause the at least one processing device to: determine a second authentication protocol anomaly based on at least one of the network node validation and network node validation criteria; intercept the one or more digital network requests; and transmit a second authentication protocol anomaly notification to the first network node agent.

In some embodiments, executing the computer-readable program code is further configured to cause the at least one processing device to: identify, using an artificial intelligence (AI) engine, one or more network anomalies based on at least one of the network data, first authentication protocol, or second authentication protocol; determine, using the AI engine, one or more network anomaly remediations; transmit the one or more network anomaly remediations to a network device; receive, via the network device, determined remediations; execute, using the AI engine, the determined remediations; and transmit an anomaly remediation notification.

In some embodiments, executing the computer-readable program code is further configured to cause the at least one processing device to: generate a user interface on a display; render one or more interactive interface elements within the user interface, wherein the one or more interactive interface elements are associated with the one or more network anomaly remediations; and receive control signals from at least one device to modify the one or more interactive interface elements.

In some embodiments, executing the computer-readable program code is further configured to cause the at least one processing device to: receive at least one historical dataset; train the AI engine based on the at least one historical dataset; receive network packet anomaly data; update the at least one historical dataset with the network packet anomaly data; and retrain the AI engine based on the network packet anomaly data.

In some embodiments, executing the computer-readable program code is further configured to cause the at least one processing device to: configured to cause the at least one processing device to: determine an execution threshold associated with first authentication protocol and the second authentication protocol; transmit an MLSA success notification and the network data to a network token issuer; execute a network token transmission based on the network data; generate and transmit a network sender token to a first network device associated with the first user and a network recipient token to a second network device associated with a second user based on the one or more network accounts associated with a first user; transmit, via a third network node agent, a network token transmission confirmation alert to the second network device associated with a second user; and execute a transmission verification based on the network token transmission.

In some embodiments, executing the computer-readable program code is further configured to cause the at least one processing device to: configured to cause the at least one processing device to: determine a forecast network anomaly based on the network data and the network validation domain; and generate forecast network anomaly remediations based on the forecast network anomaly.

In another aspect, a computer program product for multi-layer secure authentication engine for digital network security, wherein the computer program product comprises at least one non-transitory computer-readable medium having computer-readable program code portion embodied therein, the computer-readable program code portions which when executed by a processing device are configured to cause a processor to: receive and extract network data from one or more digital network requests; determine one or more network accounts associated with a first user based on the network data identify a network validation domain based on the network data; transmit, via a first network node agent, the network data and the network validation domain to a multi-layer secure authentication (MLSA) engine; execute, via the MLSA engine, a first authentication protocol; transmit the network data to a second network node agent; and execute, via the MLSA engine, a second authentication protocol.

In some embodiments, the first authentication protocol comprises: initiating a first encrypted self-executing program; determining, via the first encrypted self-executing program, access control criteria based on at least the network data, wherein the network data comprises a first network node chain, a target network node chain, and network transmission resources; generating one or more network node chain graphs based on at least one of the access control criteria, wherein the one or more network node chain graphs comprise a cross network chain control graph and a network data packet flow graph; and determining a semantic threshold based on the one or more network node chain graphs.

In some embodiments, the processing device is further configured to: determine a first authentication protocol anomaly based on at least one of the access control criteria, one or more network node chain graphs, and semantic threshold; intercept the one or more digital network requests; and transmit a first authentication protocol anomaly notification to the first network node agent.

In some embodiments, the second authentication protocol comprises: identifying network node validation criteria based on at least the network data, wherein the network data further comprises a second encrypted self-executing program dataset and a first encrypted self-executing program dataset; and executing a network node validation based on at least the network validation domain, wherein the network node validation comprises a relay network validation from each network node in at least one network node chain.

In some embodiments, the processing device is further configured to: determine a second authentication protocol anomaly based on at least one of the network node validation and network node validation criteria; intercept the one or more digital network requests; and transmit a second authentication protocol anomaly notification to the first network node agent.

In another aspect, a computer-implemented method for multi-layer secure authentication engine for digital network security: receiving and extracting network data from one or more digital network requests; determining one or more network accounts associated with a first user based on the network data identify a network validation domain based on the network data; transmitting, via a first network node agent, the network data and the network validation domain to a multi-layer secure authentication (MLSA) engine; executing, via the MLSA engine, a first authentication protocol; transmitting the network data to a second network node agent; and executing, via the MLSA engine, a second authentication protocol.

In some embodiments, the first authentication protocol comprises: initiating a first encrypted self-executing program; determining, via the first encrypted self-executing program, access control criteria based on at least the network data, wherein the network data comprises a first network node chain, a target network node chain, and network transmission resources; generating one or more network node chain graphs based on at least one of the access control criteria, wherein the one or more network node chain graphs comprise a cross network chain control graph and a network data packet flow graph; and determining a semantic threshold based on the one or more network node chain graphs.

In some embodiments, the computer-implemented method is further configured for: determining a first authentication protocol anomaly based on at least one of the access control criteria, one or more network node chain graphs, and semantic threshold; intercepting the one or more digital network requests; and transmitting a first authentication protocol anomaly notification to the first network node agent.

In some embodiments, the second authentication protocol comprises: identifying network node validation criteria based on at least the network data, wherein the network data further comprises a second encrypted self-executing program dataset and a first encrypted self-executing program dataset; and executing a network node validation based on at least the network validation domain, wherein the network node validation comprises a relay network validation from each network node in at least one network node chain.

In some embodiments, the computer-implemented method is further configured for: determining a second authentication protocol anomaly based on at least one of the network node validation and network node validation criteria; intercepting the one or more digital network requests; and transmitting a second authentication protocol anomaly notification to the first network node agent.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrate technical components of an exemplary distributed computing environment for multi-layer secure authentication engine for digital network security, in accordance with an embodiment of the disclosure;

FIG. 2 illustrates an exemplary AI engine subsystem architecture, in accordance with an embodiment of the disclosure;

FIGS. 3A-3B illustrate an exemplary distributed ledger technology (DLT) architecture, in accordance with an embodiment of the disclosure;

FIG. 4 illustrates a process flow for multi-layer secure authentication engine for digital network security, in accordance with an embodiment of the disclosure;

FIG. 5 illustrates a process flow for determining a first authentication protocol anomaly, in accordance with an embodiment of the disclosure;

FIG. 6 illustrates a process flow for determining a second authentication protocol anomaly, in accordance with an embodiment of the disclosure;

FIG. 7 illustrates a process flow for determining network anomalies and network anomaly remediations using the AI engine, in accordance with an embodiment of the disclosure;

FIG. 8 illustrates a process flow for generating a user interface and rendering interactive interface elements, in accordance with an embodiment of the disclosure;

FIG. 9 illustrates a process flow for training and retraining the AI engine, in accordance with an embodiment of the disclosure;

FIG. 10 illustrates a process flow for executing a network token transmission, in accordance with an embodiment of the disclosure; and

FIG. 11 illustrates a process flow for determining forecast network anomalies and generating forecast network anomaly remediations, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, this data may be related to the people who work for the organization, its products or services, the customers, or any other aspect of the operations of the organization. As such, the entity may be any institution, group, association, financial institution, establishment, company, union, authority, or the like, employing information technology resources for processing large amounts of data.

As described herein, a “user” may be an individual associated with an entity. As such, in some embodiments, the user may be an individual having past relationships, current relationships, or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface may include a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, “authentication credentials” may be any information that may be used to identify a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure, and positioning (e.g., distal phalanges, intermediate phalanges, proximal phalanges, and the like)), an answer to a security question, a unique intrinsic user activity (e.g., making a predefined motion with a user device), and/or the like. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources input by the plurality of users within the system. The system may further use its authentication servers to certify the identity of users of the system, such that other users may verify the identity of the certified users. In some embodiments, the entity may certify the identity of the other users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (e.g., rotationally coupled, pivotally coupled, or the like). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, a “resource” may generally refer to objects, products, devices, goods, commodities, services, and the like, and/or the ability and opportunity to access and use the same. Some example implementations herein contemplate property held by a user, including property that is stored and/or maintained by a third-party entity. In some example implementations, a resource may be associated with one or more accounts or may be property that is not associated with a specific account. Examples of resources associated with accounts may be accounts that have cash or cash equivalents, commodities, cryptocurrencies, non-fungible tokens, and/or accounts that are funded with or contain property, such as safety deposit boxes containing jewelry, art or other valuables, a trust account that is funded with property, or the like. For purposes of this disclosure, a resource is typically stored in a resource repository-a storage location where one or more resources are organized, stored, and retrieved electronically using a computing device.

As used herein, a “resource transfer,” “resource distribution,” or “resource allocation” may refer to any transactions, activities, or communications between one or more entities, or between the user and the one or more entities. A resource transfer may refer to any distribution of resources such as, but not limited to, network resource transfer, cryptocurrency transfer, a payment, processing of funds, purchase of goods or services, a return of goods or services, a payment transaction, a credit transaction, or other interactions involving a user's resource or account. Unless specifically limited by the context, a “resource transfer” a “transaction”, “transaction event” or “point of transaction event” may refer to any activity between a user, a merchant, an entity, or any combination thereof. In some embodiments, a resource transfer or transaction may refer to financial transactions involving direct or indirect movement of funds through traditional paper transaction processing systems (e.g., paper check processing) or through electronic transaction processing systems. Typical financial transactions include point of sale (POS) transactions, person-to-person (P2P) transfers, internet transactions, online shopping, electronic funds transfers between accounts, cryptocurrency transactions, distributed ledger transaction, transactions with a financial institution teller, conducting purchases using loyalty/rewards points, etc. When discussing that resource transfers or transactions are evaluated, it could mean that the transaction has already occurred, is in the process of occurring or being processed, or that the transaction has yet to be processed/posted by one or more financial institutions. In some embodiments, a resource transfer or transaction may refer to non-financial activities of the user. In this regard, the transaction may be a customer account event, such as but not limited to the customer changing a password, accessing an existing account, adding new accounts, opening new accounts, adding or modifying account parameters/restrictions, modifying a payee list associated with one or more accounts, setting up automatic payments, performing/modifying authentication procedures and/or credentials, and the like.

As used herein, “payment instrument” may refer to account identifying information stored electronically in a user device, such as payment credentials or tokens/aliases associated with a digital wallet, or account identifiers stored by a mobile application.

Accordingly, the present disclosure is directed to a multi-layer secure authentication engine for digital network security. The present disclosure is configured to utilize an MLSA engine to ensure the security and performance efficiency of cross-distributed ledger network transmissions and transactions, such as transmitting data objects, tokens associated with an object, non-fungible tokens, and/or cryptocurrencies. Security threats impacting such cross-distributed ledger network transmissions include token hijacking and manipulating vulnerable encrypted self-executing programs. The MLSA engine uses a multi-phase approach for authentication and validation to remediate malicious actions, identify and stop unauthorized network transmissions, and prevent misuse of tokens. Only upon successful completion of authentication actions by the MLSA engine will the present disclosure be configured to execute cross-distributed ledger network transmissions and transactions.

The present disclosure is configured to receive one or more digital network requests, extracts network data, and determines a network validation domain (such as proof-of-work, proof-of-stake, hybrid validation methodologies, network authentication, and/or the like). A first network node agent transmits the network data to the MLSA engine, which executes the first phase of the multi-layer secure authentication. The first phase comprises verifying access control criteria and a semantic threshold to detect network anomalies. Upon detecting a network anomaly, the MLSA engine initiates a halting procedure, which comprises error handling and remediation actions. Such error handling and remediation actions comprise intercepting in-process network transmissions, halting processing, implementing revised security protocols, and/or redirecting network traffic.

Upon successful execution of the first phase, such as when no network anomalies are detected, the MLSA engine executes the second phase of the multi-layer secure authentication. The second phase comprises transmitting the network data to a second network node agent and verifying network node block headers by leveraging the network validation domain. If a network anomaly is detected during this second phase, the MLSA engine initiates a halting procedure, which comprises error handling and remediation actions. Such error handling and remediation actions comprise intercepting in-process network transmissions, halting processing, implementing revised security protocols, and/or redirecting network traffic. Upon successful execution of the second phase, such as when no network anomalies are detected, the network data is transmitted to a third network node agent for additional processing and execution of cross-distributed ledger network transmissions. The present disclosure is also configured to utilize an AI engine to detect network anomalies, generate network anomaly remediations, and determine forecast network anomalies and network anomaly remediations.

What is more, the present disclosure provides a technical solution to a technical problem. As described herein, the technical problem includes security protocol challenges associated with cross-distributed ledger network transmissions and transactions, such as token hijacking and leveraging compromised encrypted self-executing programs. The technical solution presented herein allows for a multi-layer secure authentication engine for digital network security, which increases security of cross-distributed ledger interactions by implementing a multi-phase authentication and validation approach to verifications. In particular, the multi-layer secure authentication engine for digital network security is an improvement over existing solutions to the technical challenges and security protocol challenges associated with cross-distributed ledger network transmissions and transactions, (i) with fewer steps to achieve the solution, thus reducing the amount of computing resources, such as processing resources, storage resources, network resources, and/or the like, that are being used (e.g., utilizing the MLSA engine to execute a dynamic, intelligent, and automated multi-phase security approach to detect and remediate network anomalies), (ii) providing a more accurate solution to problem, thus reducing the number of resources required to remedy any errors made due to a less accurate solution (e.g., providing automated network anomaly detection, which saves resource consumption by halting anomalous requests during request execution), (iii) removing manual input and waste from the implementation of the solution, thus improving speed and efficiency of the process and conserving computing resources (e.g., by utilizing the MLSA engine for continuous anomaly detection, generating anomaly remediation recommendations via an AI engine, and executing mitigating responsive actions in real-time), (iv) determining an optimal amount of resources that need to be used to implement the solution, thus reducing network traffic and load on existing computing resources (e.g., by leveraging the MLSA engine for secure multi-layer authentication and an AI engine for dynamic, automated remediations). Furthermore, the technical solution described herein uses a rigorous, computerized process to perform specific tasks and/or activities that were not previously performed. In specific implementations, the technical solution bypasses a series of steps previously implemented, thus further conserving computing resources.

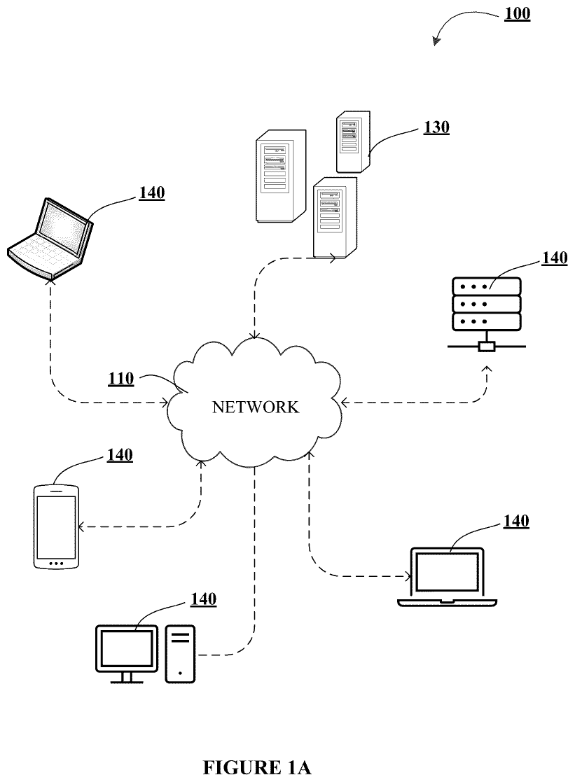

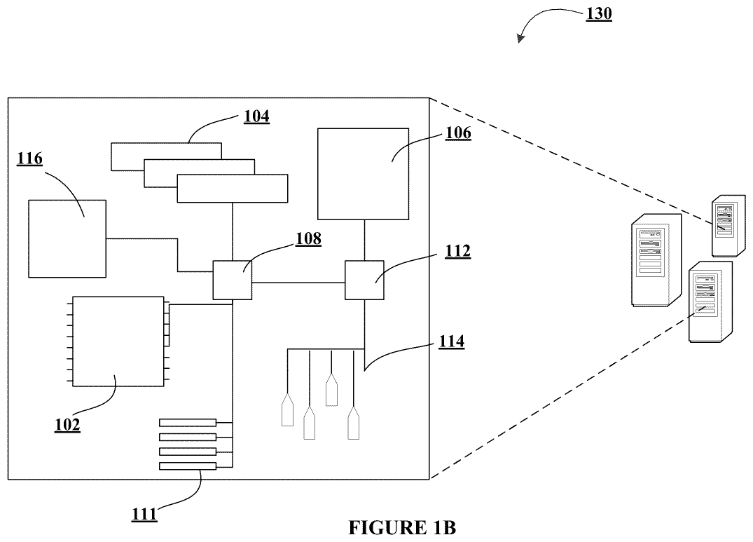

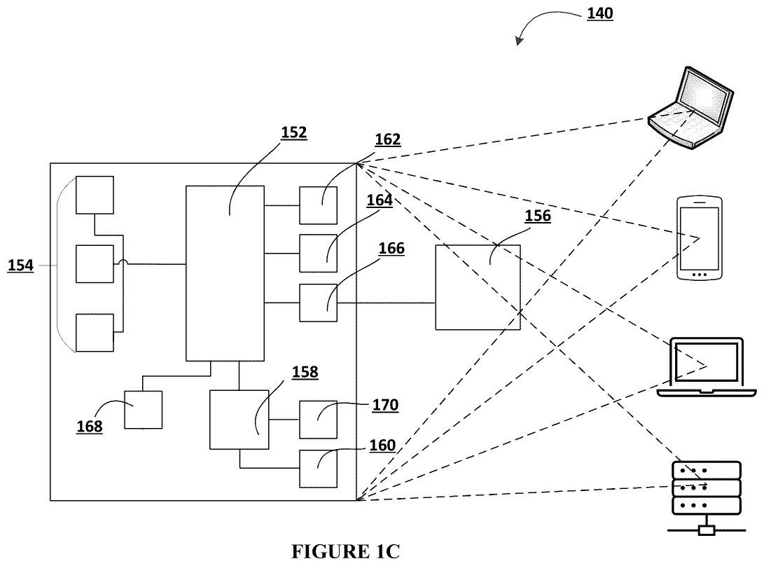

FIGS. 1A-1C illustrate technical components of an exemplary distributed computing environment for multi-layer secure authentication engine for digital network security 100, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connected to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, entertainment consoles, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which may be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, input/output (I/O) device 116, and a storage device 106. The system 130 may also include a high-speed interface 108 connecting to the memory 104, and a low-speed interface 112 connecting to low-speed bus 114 and storage device 106. Each of the components 102, 104, 106, 108, 112 and 114 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 106, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product may be tangibly embodied in an information carrier. The computer program product may also contain instructions that, when executed, perform one or more methods, such as those described above. The information carrier may be a non-transitory computer-or machine-readable storage medium, such as the memory 104, the storage device 106, or memory on processor 102.

The high-speed interface 108 manages bandwidth-intensive operations for the system 130, while the low-speed interface/controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, the low-speed interface/controller 112 is coupled to storage device 106 and low-speed bus/expansion port 114. The low-speed bus/expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor 152 may be implemented as a chipset of chips that include separate and multiple analog and digital processors. The processor 152 may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 166 may comprise appropriate circuitry and may be configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 may be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier may be a computer-or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through the communication interface 158, which may include digital signal processing circuitry where necessary. The communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, a GPS (Global Positioning System) receiver module 170 may provide additional navigation and location-related wireless data to end-point device(s) 140, which may be used as appropriate by applications running thereon, and in some embodiments, one or more applications operating on the system 130.

The end-point device(s) 140 may also communicate audibly using an audio codec 162, which may receive spoken information from a user and convert the spoken information to usable digital information. The audio codec 162 may likewise generate audible sound for a user, such as through a speaker (e.g., in a handset of end-point device(s) 140). Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described herein may be realized in digital electronic circuitry, integrated circuitry, specially designed ASICs (application specific integrated circuits), computer hardware, firmware, software, and/or combinations thereof.

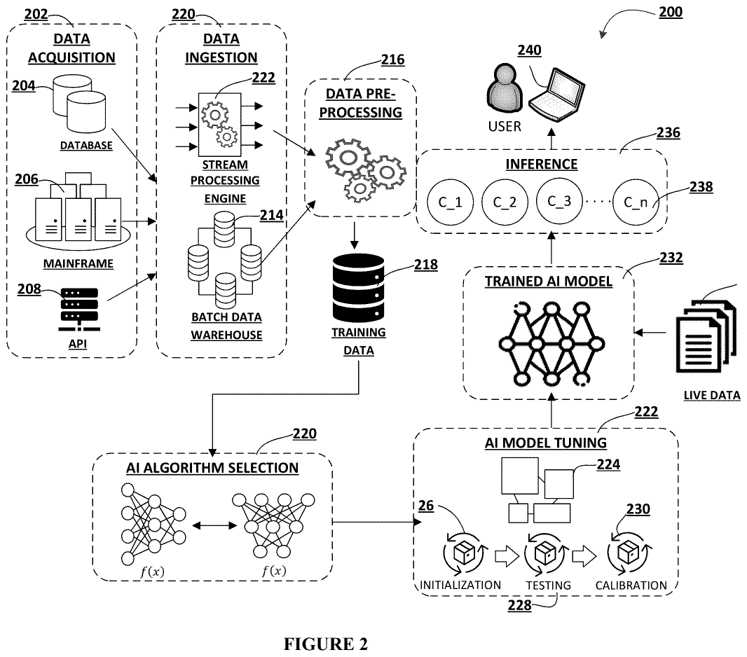

FIG. 2 illustrates an exemplary artificial intelligence (AI) subsystem architecture 200, in accordance with an embodiment of the disclosure. The machine learning subsystem 200 may include a data acquisition engine 202, data ingestion engine 210, data pre-processing engine 216, AI model tuning engine 222, and inference engine 236.

The data acquisition engine 202 may identify various internal and/or external data sources to generate, test, and/or integrate new features for training the machine learning model 224. These internal and/or external data sources 204, 206, and 208 may be initial locations where the data originates or where physical information is first digitized. The data acquisition engine 202 may identify the location of the data and describe connection characteristics for access and retrieval of data. In some embodiments, data is transported from each data source 204, 206, or 208 using any applicable network protocols, such as the File Transfer Protocol (FTP), Hyper-Text Transfer Protocol (HTTP), or any of the myriad Application Programming Interfaces (APIs) provided by websites, networked applications, and other services. In some embodiments, the these data sources 204, 206, and 208 may include Enterprise Resource Planning (ERP) databases that host data related to day-to-day business activities such as accounting, procurement, project management, exposure management, supply chain operations, and/or the like, mainframe that is often the entity's central data processing center, edge devices that may be any piece of hardware, such as sensors, actuators, gadgets, appliances, or machines, that are programmed for certain applications and can transmit data over the internet or other networks, and/or the like. The data acquired by the data acquisition engine 202 from these data sources 204, 206, and 208 may then be transported to the data ingestion engine 210 for further processing.

Depending on the nature of the data imported from the data acquisition engine 202, the data ingestion engine 210 may move the data to a destination for storage or further analysis. Typically, the data imported from the data acquisition engine 202 may be in varying formats as they come from different sources, including RDBMS, other types of databases, S3 buckets, CSVs, or from streams. Since the data comes from different places, it needs to be cleansed and transformed so that it can be analyzed together with data from other sources. At the data ingestion engine 202, the data may be ingested in real-time, using the stream processing engine 212, in batches using the batch data warehouse 214, or a combination of both. The stream processing engine 212 may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse 214 collects and transfers data in batches according to scheduled intervals, trigger events, or any other logical ordering.

In machine learning, the quality of data and the useful information that can be derived therefrom directly affects the ability of the machine learning model 224 to learn. The data pre-processing engine 216 may implement advanced integration and processing steps needed to prepare the data for machine learning execution. This may include modules to perform any upfront, data transformation to consolidate the data into alternate forms by changing the value, structure, or format of the data using generalization, normalization, attribute selection, and aggregation, data cleaning by filling missing values, smoothing the noisy data, resolving the inconsistency, and removing outliers, and/or any other encoding steps as needed.

In addition to improving the quality of the data, the data pre-processing engine 216 may implement feature extraction and/or selection techniques to generate training data 218. Feature extraction and/or selection is a process of dimensionality reduction by which an initial set of data is reduced to more manageable groups for processing. A characteristic of these large data sets is a large number of variables that require a lot of computing resources to process. Feature extraction and/or selection may be used to select and/or combine variables into features, effectively reducing the amount of data that must be processed, while still accurately and completely describing the original data set. Depending on the type of machine learning algorithm being used, this training data 218 may require further enrichment. For example, in supervised learning, the training data is enriched using one or more meaningful and informative labels to provide context so a machine learning model can learn from it. For example, labels might indicate whether a photo contains a bird or car, which words were uttered in an audio recording, or if an x-ray contains a tumor. Data labeling is required for a variety of use cases including computer vision, natural language processing, and speech recognition. In contrast, unsupervised learning uses unlabeled data to find patterns in the data, such as inferences or clustering of data points.

The AI model tuning engine 222 may be used to train a machine learning model 224 using the training data 218 to make predictions or decisions without explicitly being programmed to do so. The machine learning model 224 represents what was learned by the selected machine learning algorithm 220 and represents the rules, numbers, and any other algorithm-specific data structures required for classification. Selecting the right machine learning algorithm may depend on a number of different factors, such as the problem statement and the kind of output needed, type and size of the data, the available computational time, number of features and observations in the data, and/or the like. Machine learning algorithms may refer to programs (math and logic) that are configured to self-adjust and perform better as they are exposed to more data. To this extent, machine learning algorithms are capable of adjusting their own parameters, given feedback on previous performance in making prediction about a dataset.

The machine learning algorithms contemplated, described, and/or used herein include supervised learning (e.g., using logistic regression, using back propagation neural networks, using random forests, decision trees, or the like), unsupervised learning (e.g., using an Apriori algorithm, using K-means clustering), semi-supervised learning, reinforcement learning (e.g., using a Q-learning algorithm, using temporal difference learning), and/or any other suitable machine learning model type. Each of these types of machine learning algorithms can implement any of one or more of a regression algorithm (e.g., ordinary least squares, logistic regression, stepwise regression, multivariate adaptive regression splines, locally estimated scatterplot smoothing, or the like), an instance-based method (e.g., k-nearest neighbor, learning vector quantization, self-organizing map, or the like), a regularization method (e.g., ridge regression, least absolute shrinkage and selection operator, elastic net, or the like), a decision tree learning method (e.g., classification and regression tree, iterative dichotomiser 3, C4.5, chi-squared automatic interaction detection, decision stump, random forest, multivariate adaptive regression splines, gradient boosting machines, or the like), a Bayesian method (e.g., naïve Bayes, averaged one-dependence estimators, Bayesian belief network, or the like), a kernel method (e.g., a support vector machine, a radial basis function, or the like), a clustering method (e.g., k-means clustering, expectation maximization, or the like), an associated rule learning algorithm (e.g., an Apriori algorithm, an Eclat algorithm, or the like), an artificial neural network model (e.g., a Perceptron method, a back-propagation method, a Hopfield network method, a self-organizing map method, a learning vector quantization method, or the like), a deep learning algorithm (e.g., a restricted Boltzmann machine, a deep belief network method, a convolution network method, a stacked auto-encoder method, or the like), a dimensionality reduction method (e.g., principal component analysis, partial least squares regression, Sammon mapping, multidimensional scaling, projection pursuit, or the like), an ensemble method (e.g., boosting, bootstrapped aggregation, AdaBoost, stacked generalization, gradient boosting machine method, random forest method, or the like), and/or the like.

To tune the machine learning model, the AI model tuning engine 222 may repeatedly execute cycles of experimentation 226, testing 228, and tuning 230 to optimize the performance of the machine learning algorithm 220 and refine the results in preparation for deployment of those results for consumption or decision making. To this end, the AI model tuning engine 222 may dynamically vary hyperparameters each iteration (e.g., number of trees in a tree-based algorithm or the value of alpha in a linear algorithm), run the algorithm on the data again, then compare its performance on a validation set to determine which set of hyperparameters results in the most accurate model. The accuracy of the model is the measurement used to determine which set of hyperparameters is best at identifying relationships and patterns between variables in a dataset based on the input, or training data 218. A fully trained machine learning model 232 is one whose hyperparameters are tuned and model accuracy maximized.

The trained machine learning model 232, similar to any other software application output, can be persisted to storage, file, memory, or application, or looped back into the processing component to be reprocessed. More often, the trained machine learning model 232 is deployed into an existing production environment to make practical business decisions based on live data 234. To this end, the machine learning subsystem 200 uses the inference engine 236 to make such decisions. The type of decision-making may depend upon the type of machine learning algorithm used. For example, machine learning models trained using supervised learning algorithms may be used to structure computations in terms of categorized outputs (e.g., C_1, C_2 . . . C_n 238) or observations based on defined classifications, represent possible solutions to a decision based on certain conditions, model complex relationships between inputs and outputs to find patterns in data or capture a statistical structure among variables with unknown relationships, and/or the like. On the other hand, machine learning models trained using unsupervised learning algorithms may be used to group (e.g., C_1, C_2 . . . C_n 238) live data 234 based on how similar they are to one another to solve exploratory challenges where little is known about the data, provide a description or label (e.g., C_1, C_2 . . . C_n 238) to live data 234, such as in classification, and/or the like. These categorized outputs, groups (clusters), or labels are then presented to the user input system 130. In still other cases, machine learning models that perform regression techniques may use live data 234 to predict or forecast continuous outcomes.

It will be understood that the embodiment of the machine learning subsystem 200 illustrated in FIG. 2 is exemplary and that other embodiments may vary. As another example, in some embodiments, the machine learning subsystem 200 may include more, fewer, or different components.

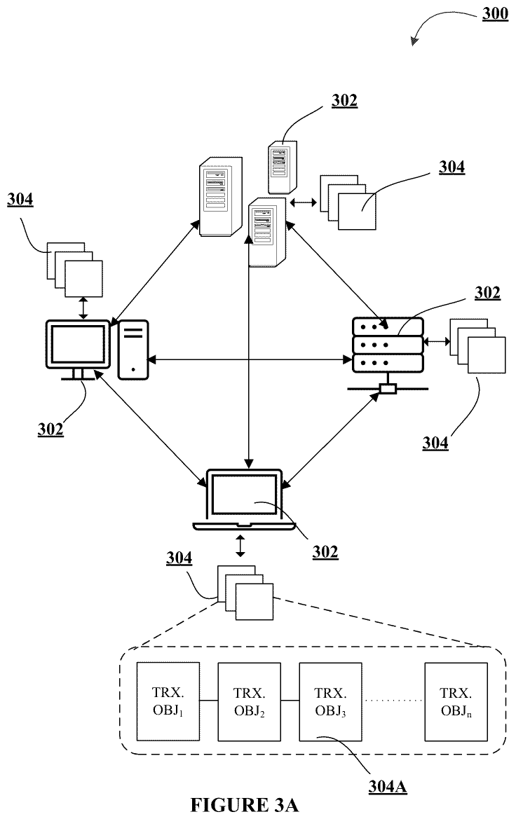

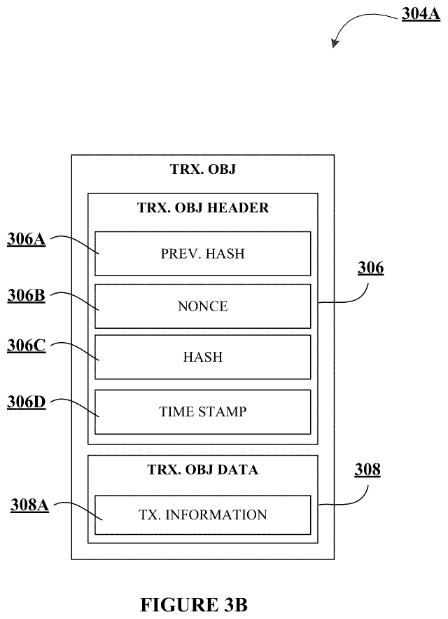

FIGS. 3A-3B illustrate an exemplary distributed ledger technology (DLT) architecture, in accordance with an embodiment of the disclosure. DLT may refer to the protocols and/or supporting infrastructure that allow computing devices (peers) in different locations to propose and validate transactions and update records in a synchronized way across a network. Accordingly, DLT is based on a decentralized model, in which these peers collaborate and build trust over the network. To this end, DLT involves the use of potentially peer-to-peer protocol for a cryptographically secured distributed ledger of transactions represented as transaction objects that are linked. As transaction objects each contain information about the transaction object previous to it, they are linked with each additional transaction object, reinforcing the transaction objects before it. Therefore, distributed ledgers are resistant to modification of their data because once recorded, the data in any given transaction object cannot be altered retroactively without altering all subsequent transaction objects.

To permit transactions and agreements to be carried out among various peers without the need for a central authority or external enforcement mechanism, DLT uses smart contracts. Smart contracts are computer code that automatically execute all of or parts of an agreement and are stored on a DLT platform. The code can either be the sole manifestation of the agreement between the parties or might complement a traditional text-based contract and execute certain provisions, such as transferring funds from Party A to Party B. The code itself may be replicated across multiple nodes (peers) and, therefore, may benefit from the security, permanence, and immutability that a distributed ledger offers. That replication also means that as each new transaction object is added to the distributed ledger, the code is, in effect, executed. If the parties have indicated, by initiating a transaction, that certain parameters have been met, the code will execute the step triggered by those parameters. If no such transaction has been initiated, the code will not take any steps.

Various other specific-purpose implementations of distributed ledgers have been developed. These include distributed domain name management, decentralized crowd-funding, synchronous/asynchronous communication, decentralized real-time ride sharing and even a general purpose deployment of decentralized applications. In some embodiments, a distributed ledger may be characterized as a public distributed ledger, a consortium distributed ledger, or a private distributed ledger. A public distributed ledger is a distributed ledger that anyone in the world can read, anyone in the world may send transactions to and expect to see them included if they are valid, and anyone in the world can participate in the consensus process for determining which transaction objects are added to the distributed ledger and what the current state of each transaction object is. A public distributed ledger is generally considered to be fully decentralized. On the other hand, a fully private distributed ledger is a distributed ledger whereby permissions are kept centralized with one entity. The permissions may be public or restricted to an arbitrary extent. And lastly, a consortium distributed ledger is a distributed ledger where the consensus process is controlled by a pre-selected set of nodes; for example, a distributed ledger may be associated with a number of member institutions (say 15), each of which operate in such a way that at least 10 members must sign every transaction object in order for the transaction object to be valid. The right to read such a distributed ledger may be public or restricted to the participants. These distributed ledgers may be considered partially decentralized.

As shown in FIG. 3A, the exemplary DLT architecture 300 may include a distributed ledger 304 being maintained on multiple devices (nodes) 302 that are authorized to keep track of the distributed ledger 304. For example, the nodes 302 may be computing devices such as the system 130 and the client device(s) 140. One node of the nodes 302 in the DLT architecture 300 may have a complete or partial copy of the entire distributed ledger 304 or may have a set of transactions and/or transaction objects 304A on the distributed ledger 304. Transactions may be initiated at a node and communicated to the nodes 302 in the DLT architecture 300. Any of the nodes 302 may validate a transaction, record the transaction to its copy of the distributed ledger, and/or broadcast the transaction, its validation (in the form of a transaction object), and/or other data to other nodes.

As shown in FIG. 3B, an exemplary transaction object 304A may include a transaction object header 306 and transaction object data 308. The transaction object header 306 may include a cryptographic hash of a previous transaction object 306A, a nonce 306B (e.g., a randomly generated 32-bit whole number when the transaction object 304A is created), a cryptographic hash of the current transaction object 306C wedded to the nonce 306B, and/or a time stamp 306D. The transaction object data 308 may include transaction information 308A being recorded. Once the transaction object 304A is generated, the transaction information 308A is considered signed and forever tied to the nonce 306B and the cryptographic hash 306C. Once generated, the transaction object 304A is then deployed on the distributed ledger 304. At this time, a distributed ledger address may be generated for the transaction object 304A (e.g., an indication of where the transaction object 304A is located on the distributed ledger 304) and may be captured for recording purposes. Once deployed, the transaction information 308A is considered recorded in the distributed ledger 304.

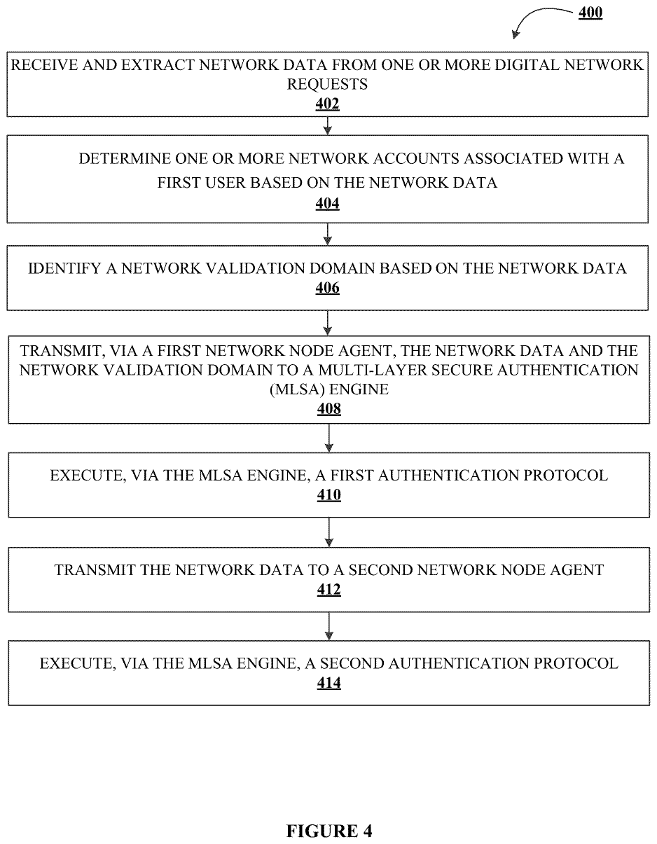

FIG. 4 illustrates a process flow 400 for multi-layer secure authentication engine for digital network security, in accordance with an embodiment of the disclosure. In some embodiments, a system (e.g., similar to one or more of the systems described herein with respect to FIGS. 1A-1C) may perform one or more of the steps of process flow 400. For example, a multi-layer secure authentication engine for digital network security system (e.g., the system 130 described herein with respect to FIGS. 1A-1C) may perform the steps of process flow 400. In some embodiments, an AI engine (e.g., such as the AI engine like that described in FIG. 2) or a DLT architecture (e.g., such as the DLT architecture described in FIG. 3) may perform some or all of the steps described in process flow 400.

As shown in block 402, the process flow 400 may include the step of receiving and extracting network data from one or more digital network requests. In some embodiments of the disclosure, the system, AI engine, and/or the like may receive and extract the network data dynamically, continuously, via on-demand trigger, via batch processing, and/or the like. According to some embodiments, receiving and extracting network data may comprise authenticating one or more devices associated with the one or more digital network requests. Based on the network data, metadata associated with the one or more digital network requests, and/or IP address associated with the one or more devices associated with the one or more digital network requests, the system and/or AI engine may dynamically select one or more authentication methods (e.g., such as via multi-factor, one-time password, authentication credentials, token, batch, trust algorithm, and/or the like) to authenticate the one or more devices. If the authentication fails, the system and/or AI engine may determine to initiate an authentication loop and execute one or more additional attempts for authentication. The system may log each authentication attempt and/or may transmit notifications relating to success and failure of each authentication attempt, according to some embodiments.

The one or more digital network requests may comprise a request associated with a network transmission, network data packet transmission, network data transmission, cryptocurrency transmission, non-fungible token (NFT) transfer, token transfer, cross-distributed ledger transmission, intra-distributed ledger transmission, distributed ledger for secure data transfer, and/or the like, according to some embodiments. The one or more digital network requests may be initiated via device associated with a first user, via mobile application, via client-device request, via push notification, via text message, via network communication, and/or the like.

According to some embodiments, the network data may comprise tokens, cryptocurrencies, NFTs, one or more automated self-executing agreements secured by a cryptographically-protected decentralized network, network accounts associated with a user, a requested transmission value, requested transmission execution time, network data packets, distributed ledger network data packets, metadata associated with network data, and/or the like. In some embodiments, the network data may comprise a network file, memory location of a repository, unique identification number, distributed ledger transaction metadata, distributed ledger transaction data, network transmission sender data (e.g., IP address for one or more network devices, distributed ledger accounts associated with the network transmission sender, reference address associated with the network transmission sender, and/or network resource account associated with the network transmission sender), network transmission receiver data (e.g., IP address for the one or more network devices, accounts associated with the network transmission recipient, reference address associated with the network transmission recipient, and/or network resource account associated with the network transmission recipient), metadata associated with the network transmission, network transmission bandwidth requirements, network transmission data security requirements, network transmission identifier data (e.g., unique identification data), digital signature, security certificate, cryptographic signature, analytics associated with network traffic, and/or the like.

As shown in block 404, the process flow 400 may include the step of determining one or more network accounts associated with a first user based on the network data. According to some embodiments of the disclosure, determining one or more network accounts associated with the first user based on the network data may comprise generating one or more new network accounts and/or accessing one or more existing accounts associated with the first user.

In some embodiments, the system, AI engine, and/or the like may access and parse the network data using a natural language processing (NLP) algorithm to extract and determine identifying user data, identify and authenticate a device associated with the first user (via multifactor authentication, token-based authentication, cross-network domain authentication, certificate based authentication, and/or hashing), query one or more repositories (e.g., internal databases, one or more unaffiliated distributed ledgers, one or more affiliated distributed ledgers, open-source repositories, and/or the like) to determine the one or more network accounts associated with the first user, and/or access network account data associated with the one or more network accounts.

In some embodiments, the system, AI engine, and/or the like may generate one or more new and/or additional network accounts associated with the first user with the first user based on the network data. By way of non-limiting example, and in some embodiments, the network data may comprise account generation data for creating and maintaining one or more network accounts, the system and/or AI engine may access such account generation data, and/or create the one or more new and/or additional network accounts based on the account generation data. According to some embodiments, an account generation message may be generated and transmitted to a device associated with the first user upon successful generation of the one or more new and/or additional network accounts, wherein the device associated with the first user may comprise a mobile device, network device, laptop, connected vehicle, and/or the like.

As shown in block 406, the process flow 400 may include the step of identifying a network validation domain based on the network data. In some embodiments, the system and/or AI engine may identify a network validation data domain based on the network work data to determine a mode, process, protocol, and/or the like for validating, authenticating, and/or authorizing execution of the one or more one or more digital network requests. The network validation data domain may be associated with one or more distributed ledger systems for secure data transfer, systems for digital representation of ownership utilizing a distributed secure database, distributed record-keeping systems for traceability in logistics, decentralized systems for validation and storage of digital identity data, network node threats, network node chains, and/or the like. According to some embodiments, the network validation domain may comprise network access controls, authentication methods and/or requirements, data security requirements, geographic restrictions on data transmissions, restricted network ports, firewall configurations, proof-of-stake, proof-of-work, practical byzantine fault tolerance, hybrid consensus methods (e.g., utilizing at least two of proof-of-stake, proof-of-work, practical byzantine fault tolerance, and/or the like).

As shown in block 408, the process flow 400 may include the step of transmitting, via a first network node agent, the network data and the network validation domain to a multi-layer secure authentication (MLSA) engine. In some embodiments, the first network node agent may comprise a distributed ledger exchange traffic node, network gateway, network device, firewall, and/or the like. In some embodiments, the network data and the network validation domain may be transmitted via network data packets, network transmission, and/or Extract, Transform, and Load (ETL) process. The first network node agent may receive transmissions continuously, dynamically in real-time, and/or via batch processing. In some embodiments, the first network node agent may process received transmissions, such as encrypting data, decrypting data using a known hash, cleaning data, and/or the like.

In some embodiments, the MLSA engine comprises an engine that executes at least two modes of authentication related to the one or more digital network requests. In some embodiments, the MLSA engine may comprise an AI engine. The MLSA engine may execute the modes of authentication in series and/or in parallel (e.g., execute one mode of authentication in parallel with two modes of authentication executing in series). In some embodiments, the MLSA engine executes a MLSA protocol to validate data for executing a distributed ledger transaction, transmission, and/or the like.

As shown in block 410, the process flow 400 may include the step of executing, via the MLSA engine, a first authentication protocol. In some embodiments, first authentication protocol may comprise retrieving access control criteria and semantic identification data via the first network node agent. The first authentication protocol may comprise a SmartAxe framework for validating access controls and semantic data, in some embodiments. The first authentication protocol may comprise initiating a first encrypted self-executing program, wherein the first encrypted self-executing program executes actions dynamically based on the network data by satisfying predetermined criteria. In some embodiments, the first encrypted self-executing program comprises a plurality of cross-chain encrypted self-executing programs, wherein the cross-chain encrypted self-executing programs comprise cross-distributed ledger bridges for validating security data and/or for executing cross-network node chain transmissions between unassociated and/or unlinked distributed ledgers. In such a configuration, and in some embodiments, the first encrypted self-executing program identifies network vulnerabilities by evaluating access control criteria and a semantic threshold. In some embodiments, the first authentication protocol may comprise pre-processing data and separately recovering network data flow (such as control flow and/or data flow) of the plurality of cross-chain encrypted self-executing programs on each side of a cross-distributed ledger bridge.

According to some embodiments, the first authentication protocol may comprise determining, via the first encrypted self-executing program, access control criteria based on at least the network data, wherein the network data comprises a first network node chain, a target network node chain, and network transmission resources. In some embodiments, the access control criteria may comprise signatory validations (e.g., validating authenticity of signatures, certificates, and/or the like prior to executing a network transmission), data security requirements, network access controls, authentication credentials, heightened security requirements for sensitive data, and/or the like. A failure of any access control criteria may comprise a network vulnerability detected by the first authentication protocol, wherein a failure may comprise failing to meet or exceed any threshold associated with the access control criteria. According to some embodiments, the system, MLSA engine, and/or AI engine may compare access control criteria to predetermined security requirements to determine if the access control criteria is equal to, exceeds, and/or is below a security threshold. In such configurations, and in some embodiments, the first authentication protocol may succeed if the security threshold is met and/or exceeded by the access control criteria.

In some embodiments the first network node chain may comprise a distributed ledger associated with a network account associated with the first user, wherein the first network node chain may comprise a distributed ledger on one side of a cross-distributed ledger bridge. The target network node chain may comprise a distributed ledger associated with a network account associated with a second user, wherein the target network node chain may comprise a distributed ledger on a side of a cross-distributed ledger bridge opposite of the first network node chain. In some embodiments, the network transmission resources may comprise metadata associated with network devices and/or equipment, tokens, NFTs, cryptocurrencies, and/or the like. Furthermore, the first authentication protocol may comprise aligning control flow, control flow dependencies, data flow, and/or data flow dependencies across the cross-distributed ledger bridge.

In some embodiments, the first authentication protocol may comprise generating one or more network node chain graphs based on at least one of the access control criteria, wherein the one or more network node chain graphs comprise a cross network chain control graph and a network data packet flow graph. In some embodiments, the one or more network node chain graphs may be associated with a single cross-distributed ledger bridge, a plurality of cross-distributed ledger bridges, and/or there may be one or more network node chain graphs generated for each cross-distributed ledger bridge. In some embodiments, the system, MLSA engine, and/or AI engine may generate the one or more network node chain graphs. In some embodiments, the first authentication protocol may comprise modeling heterogeneous implementation of access control criteria in cross-distributed ledger bridges to canonical form. By executing such modeling, the system may utilize probabilistic pattern inference for monitoring and anomaly detection, improving security and data integrity of the system.

In some embodiments, the cross network chain control graph may comprise network nodes associated with operations of an application program, including without limitation encrypted self-executing programs, a relayer node associated with cross-network node transmissions, and/or client node associated with a client network device associated with the cross-distributed ledger bridge. In some embodiments, the cross network chain control graph may be generated by aligning encrypted self-executing programs between the first network node chain and the target network node chain. According to some embodiments, the cross network chain control graph may comprise a topographical visualization of network nodes, network edges, and/or network traffic transmitting between relayer nodes and client nodes during triggering events via cross-network node transmissions. The cross network chain control graph may be generated and/or updated dynamically in real-time, upon an event trigger (e.g., user request, anomaly detection, spike in abnormal traffic patterns, and/or the like), and/or via batch processing at set intervals. The cross network chain control graph may be displayed for real-time, dynamic network monitoring and anomaly detection, enhancing security of the system.

In some embodiments, the network data packet flow graph may comprise analyzing network data packet flows of the cross network chain control graph. Furthermore, in some embodiments, the network data packet flow graph may comprise a data flow evaluation, which may comprise analyzing a subset of network data traffic flowing from network edges to the relayer node. This subset of network data traffic, in some embodiments, may comprise the entire dataset transmitted across the cross-distributed ledger bridge during a cross-network node transmissions. network data packet flow graph may be generated and/or updated dynamically in real-time, upon an event trigger (e.g., updates to the cross network chain control graph, user request, anomaly detection, spike in abnormal traffic patterns, and/or the like), and/or via batch processing at set intervals. The network data packet flow graph may be displayed for real-time, dynamic network monitoring and anomaly detection, enhancing security of the system.

According to some embodiments, the first authentication protocol may comprise determining a semantic threshold based on the one or more network node chain graphs. In some embodiments, the system, MLSA engine, and/or AI engine may determine the semantic thresholds based on predetermined thresholds, external thresholds transmitted to the system, user request, and/or based on the one or more network node chain graphs. The semantic threshold may be generated and/or updated dynamically in real-time, upon an event trigger (e.g., updates to the one or more network node chain graphs, user request, anomaly detection, spike in abnormal traffic patterns, and/or the like), and/or via batch processing at set intervals.

In some embodiments, the system, MLSA engine, and/or AI engine may evaluate the one or more network node graphs to determine that the encrypted self-executing programs lack requisite semantic granularity associated with a network event trigger, which may comprise failing the semantic threshold. In some embodiments, the system, MLSA engine, and/or AI engine may evaluate the one or more network node graphs to determine the encrypted self-executing programs comprise requisite semantic granularity, which may comprise surpassing and/or meeting the semantic threshold. The system, MLSA engine, and/or AI engine may log all instances in which the encrypted self-executing programs lack, meet, and/or exceed requisite semantic granularity and transmit an outputted log to a network device via encrypted network communication linkage.

In some embodiments, the system, MLSA engine, and/or AI engine may evaluate the one or more network node graphs and/or one or more encrypted self-executing programs to determine if any function of the one or more encrypted self-executing programs lacks network traffic data flow dependencies. In such embodiments, the semantic threshold may not be met. In some embodiments, the system, MLSA engine, and/or AI engine may determine the semantic threshold is met and/or exceeded by determining that all functions of the one or more encrypted self-executing programs comprises network traffic data flow dependencies. Furthermore, the system, MLSA engine, and/or AI engine may determine the semantic threshold is met and/or exceeded by comparing the one or more network node graphs to known acceptable network node paths, reference one or more network node graphs lacking anomalies, and/or the like.

In some embodiments, the system, MLSA engine, and/or AI engine may evaluate vulnerability signals based on the access control criteria and the semantic threshold. By evaluating the vulnerability signals, the system, MLSA engine, and/or AI engine may identify and/or determine network anomalies present in any encrypted self-executing program, associated tainted data subsets associated with the encrypted self-executing programs, compromised functions and/or code within the encrypted self-executing programs, and/or network data transmissions comprising data packets transmitted by compromised network devices associated with the one or more digital network requests. In some embodiments, the second authentication protocol may be attempted one or more additional times if an initial second authentication protocol fails to successfully execute.

As shown in block 412, the process flow 400 may include the step of transmitting the network data to a second network node agent. In some embodiments, the network data may be encrypted using a cryptographic hash, key, and/or the like prior to transmission. The second network node agent may be authenticated prior to transmitting the data. In such configurations, the system, MLSA engine, and/or AI engine may dynamically select one or more authentication methods (e.g., such as via multi-factor, one-time password, authentication credentials, token, batch, trust algorithm, and/or the like) to authenticate the second network node agent. If the authentication fails, the system and/or AI engine may determine to initiate an authentication loop and execute one or more additional attempts for authentication. The system may log each authentication attempt and/or may transmit notifications relating to success and failure of each authentication attempt, according to some embodiments. Upon receiving the network data, the second network node agent may execute a decryption process via cryptographic key, hash tables, public key, private key, and/or the like. In some embodiments, the second network node agent may comprise a network node, network device, network gateway, firewall, router, switch, and/or decentralized autonomous organization.

As shown in block 414, the process flow 400 may include the step of executing, via the MLSA engine, a second authentication protocol. Alternatively, or additionally, in some embodiments, the AI engine may execute the second authentication protocol to further validate, enhancing the multi-layer security of the system. According to some embodiments, the second authentication protocol may comprise executing the first authentication protocol one or more additional times and/or a zkBridge framework, wherein zero-knowledge network validation domains, or proofs, verify headers of network node block headers and establish consensus across network node chains, distributed ledgers, and/or the like. In some embodiments, the second authentication protocol may comprise identifying network node validation criteria based on at least the network data, wherein the network data further comprises a second encrypted self-executing program dataset and a first encrypted self-executing program dataset. In some embodiments, identifying network node validation criteria may also be based on the one or more digital network requests, access control criteria, MLSA engine output, first authentication protocol output, one or more network node chain graphs, semantic threshold, and/or network anomalies.

According to some embodiments, the first encrypted self-executing program dataset and the second encrypted self-executing program dataset may comprise data from the first encrypted self-executing program and a second encrypted self-executing program, which are positioned on either side of a cross-distributed ledger bridge. In some embodiments, the second network node agent may comprise a network node block header relay network, wherein the second network node agent may retrieve network node block headers from the network data.

According to some embodiments, the second authentication protocol may comprise executing a network node validation based on at least the network validation domain, wherein the network node validation comprises a relay network validation from each network node in at least one network node chain. The second network node agent may also execute a network validation domain to validate the network node block headers, network data, first encrypted self-executing program dataset, and/or the second encrypted self-executing program dataset. In some embodiments, the second network node agent may transmit the second encrypted self-executing program dataset, network data, and/or network node validation output data to the second encrypted self-executing program. In some embodiments, the second encrypted self-executing program may further validate the network node validation, and upon successful validation, may transmit the network node block headers and/or network transmissions resources to the target network node chain. Upon successful execution of the second authentication protocol, the second network node agent may transmit a success message to a third network node agent.

According to some embodiments, the second authentication protocol may fail to authenticate and/or identify and detect anomalies. When a failure of the second authentication protocol may occur, the second network node agent may notify the first network node agent of the error, including transmitting a notification comprising second authentication protocol failure data, which may comprise an error code, error logic, error log, and/or network node data. In some embodiments, the second authentication protocol may be attempted one or more additional times. By harnessing the MLSA engine to execute the first authentication and the second authentication protocol, the system improves security of cross-network node chain transmissions and transactions between distributed ledgers. Utilizing a multi-phased approach averts malicious attacks (e.g., fifty-one percent attacks) by malicious actors against a network of distributed ledgers executing cross-network node transmissions. Such malicious attacks allow a hacker to gain control of a distributed ledger, threatening the security of the entire network associated with the distributed ledger.

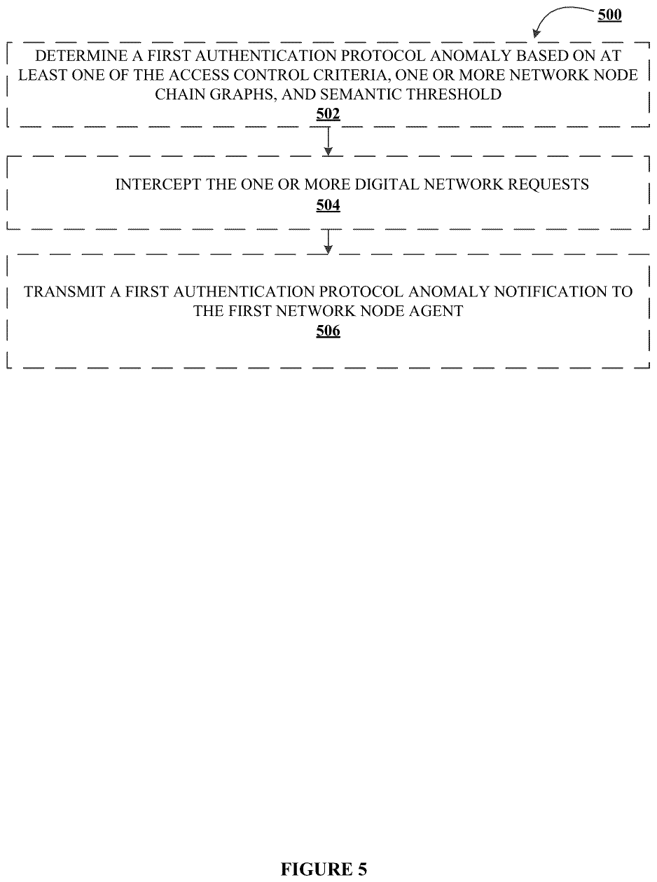

FIG. 5 illustrates a process flow 500 for determining a first authentication protocol anomaly, in accordance with an embodiment of the disclosure. In some embodiments, a system (e.g., similar to one or more of the systems described herein with respect to FIGS. 1A-1C) may perform one or more of the steps of process flow 500. For example, a multi-layer secure authentication engine for digital network security system (e.g., the system 130 described herein with respect to FIGS. 1A-1C) may perform the steps of process flow 500. In some embodiments, an AI engine (e.g., such as the AI engine like that described in FIG. 2) or a DLT architecture (e.g., such as the DLT architecture described in FIG. 3) may perform some or all of the steps described in process flow 500.

As shown in block 502, the process flow 500 may include the step of determining a first authentication protocol anomaly based on at least one of the access control criteria, one or more network node chain graphs, and semantic threshold. According to some embodiments, the first authentication protocol anomaly may comprise a failure of the first authentication protocol. A failure may occur due to anomalies with access control criteria, unauthenticated access to sensitive information, security incidents, failure to meet and/or exceed the semantic threshold, semantic inconsistencies identified with the one or more network node chain graphs, failure to authenticate a device (such as network device, user device, and/or network node agent) and/or the like.

A first authentication protocol anomaly may comprise a failure of any access control criteria detected by the first authentication protocol, wherein a failure may comprise failing to meet or exceed any threshold associated with the access control criteria. According to some embodiments, the system, MLSA engine, and/or AI engine may compare access control criteria to predetermined security requirements to determine if the access control criteria is below a security threshold, wherein the security threshold may be predetermined, determined continuously by the MLSA engine and/or AI engine, or determined at set periodic intervals. The system, MLSA engine, and/or AI engine may log all instances in which the access control criteria is below a security threshold and transmit an outputted log to a network device via encrypted network communication linkage.

A first authentication protocol anomaly may comprise evaluating the one or more network node graphs and determining that the encrypted self-executing programs lack requisite semantic granularity associated with a network event trigger, which may comprise failing the semantic threshold. In such configurations, the encrypted self-executing programs lack requisite semantic granularity, which would comprise a first authentication protocol anomaly. The system, MLSA engine, and/or AI engine may log all instances in which the encrypted self-executing programs lack requisite semantic granularity and transmit an outputted log to a network device via encrypted network communication linkage.

A first authentication protocol anomaly may comprise evaluating the one or more network node graphs and/or one or more encrypted self-executing programs and determining that any function of the one or more encrypted self-executing programs lacks network traffic data flow dependencies. In such embodiments, the semantic threshold may not be met, which comprises a first authentication protocol anomaly. In some embodiments, the system, MLSA engine, and/or AI engine may compare the one or more network node graphs to known acceptable network node paths and determine the one or more network node graphs fail to adhere to known acceptable network node paths, which may comprise a first authentication protocol anomaly.

In some embodiments, the system, MLSA engine, and/or AI engine may evaluate vulnerability signals based on the access control criteria and the semantic threshold. By evaluating the vulnerability signals, the system, MLSA engine, and/or AI engine may identify and/or determine first authentication protocol anomalies present in any encrypted self-executing program, associated tainted data subsets associated with the encrypted self-executing programs, compromised functions and/or code within the encrypted self-executing programs, and/or network data transmissions comprising data packets transmitted by compromised network devices associated with the one or more digital network requests.

As shown in block 504, the process flow 500 may include the step of intercepting the one or more digital network requests. According to some embodiments, intercepting the one or more digital network requests may comprise intercepting network traffic transmitted to the first network node agent, second network node agent, any network device, device associated with the first user, and/or the like. In some embodiments, intercepting network traffic may comprise dynamically analyzing in real-time network data packets using a network monitoring application and/or AI engine and/or determining whether to route the network traffic to a different network edge and/or network port. In some embodiments, intercepting network traffic may comprise utilizing a proxy server between nodes to intercept and/or modify traffic transmitted from a sending node to a receiving node along a network edge. According to some embodiments, intercepting network traffic may comprise security socket layer interception, transport layer security interception, and/or network taps.

In some embodiments, intercepting the one or more digital network requests may comprise initiating a halt on execution of any process associated with the one or more digital network requests, adding the one or more digital network requests to an intercepted request queue for subsequent evaluation by the AI engine, evaluating logs to determine security incidents associated with the first authentication protocol anomaly, removing permissions from a device or account associated with the one or more digital network requests, blocking all traffic from a device associated with the one or more digital network requests, and/or the like.

As shown in block 506, the process flow 500 may include the step of transmitting a first authentication protocol anomaly notification to the first network node agent. In some embodiments, the MLSA engine, AI engine, and/or system may generate and/or transmit the first authentication protocol anomaly notification to the first network node agent, user device, and/or network device. In some embodiments, the first authentication protocol anomaly notification may comprise transmitting network data packets, text message, email, instant message, audio transmissions, video transmissions, alert via user interface, and/or push notification to a mobile device. According to some embodiments, the first authentication protocol anomaly notification may be transmitted via communication channel, may comprise end-to-end encryption, a secure socket layer, transport layer security, and/or the like.

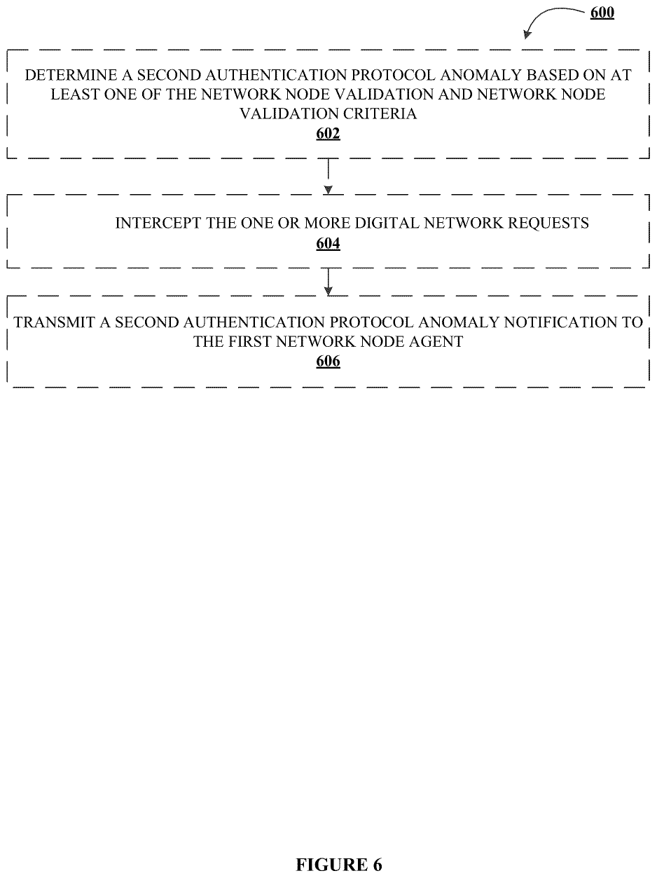

FIG. 6 illustrates a process flow 600 for determining a second authentication protocol anomaly, in accordance with an embodiment of the disclosure. In some embodiments, a system (e.g., similar to one or more of the systems described herein with respect to FIGS. 1A-1C) may perform one or more of the steps of process flow 600. For example, a multi-layer secure authentication engine for digital network security system (e.g., the system 130 described herein with respect to FIGS. 1A-1C) may perform the steps of process flow 600. In some embodiments, an AI engine (e.g., such as the AI engine like that described in FIG. 2) or a DLT architecture (e.g., such as the DLT architecture described in FIG. 3) may perform some or all of the steps described in process flow 600.

As shown in block 602, the process flow 600 may include the step of determining a second authentication protocol anomaly based on at least one of the network node validation and network node validation criteria. In some embodiments, the second authentication protocol anomaly may comprise a failure to transmit the network data to the second network node agent, failure to authenticate the second network node agent, and/or an interception of the network data by a malicious actor.

According to some embodiments, the second authentication protocol anomaly may comprise a failed network node validation and/or failed relay network validation from each network node in the at least one network node chain, first network node chain, target network node chain, and/or the like, which may occur when the network node validation fails to verify headers of the network node block headers network data, first encrypted self-executing program dataset, and/or the second encrypted self-executing program dataset and/or establish consensus across network node chains, distributed ledgers and/or the like. In some embodiments, the MLSA engine and/or AI engine may detect network anomalies based on the network node validation and/or network node validation criteria. In some embodiments, the second authentication protocol anomaly may comprise a failed execution of any encrypted self-executing program.

As shown in block 604, the process flow 600 may include the step of intercepting the one or more digital network requests. According to some embodiments, intercepting the one or more digital network requests may comprise intercepting network traffic transmitted to the second network node agent, third network node agent, any network device, device associated with the first user, and/or the like. In some embodiments, intercepting network traffic may comprise dynamically analyzing in real-time network data packets using a network monitoring application and/or AI engine and/or determining whether to route the network traffic to a different network edge and/or network port. In some embodiments, intercepting network traffic may comprise utilizing a proxy server between nodes to intercept and/or modify traffic transmitted from a sending node to a receiving node along a network edge. According to some embodiments, intercepting network traffic may comprise security socket layer interception, transport layer security interception, and/or network taps.

In some embodiments, intercepting the one or more digital network requests may comprise initiating a halt on execution of any process associated with the one or more digital network requests, adding the one or more digital network requests to a second intercepted request queue for subsequent evaluation by the AI engine, evaluating logs to determine security incidents associated with the second authentication protocol anomaly, removing permissions from a device or account associated with the one or more digital network requests, blocking all traffic from a device associated with the one or more digital network requests, and/or the like.

As shown in block 606, the process flow 600 may include the step of transmitting a second authentication protocol anomaly notification to the first network node agent. In some embodiments, the MLSA engine, AI engine, and/or system may generate and/or transmit the second authentication protocol anomaly notification to the first network node agent, user device, and/or network device. In some embodiments, the first authentication protocol anomaly notification may comprise transmitting network data packets, text message, email, instant message, audio transmissions, video transmissions, alert via user interface, and/or push notification to a mobile device. According to some embodiments, the second authentication protocol anomaly notification may be transmitted via communication channel, may comprise end-to-end encryption, a secure socket layer, transport layer security, and/or the like.

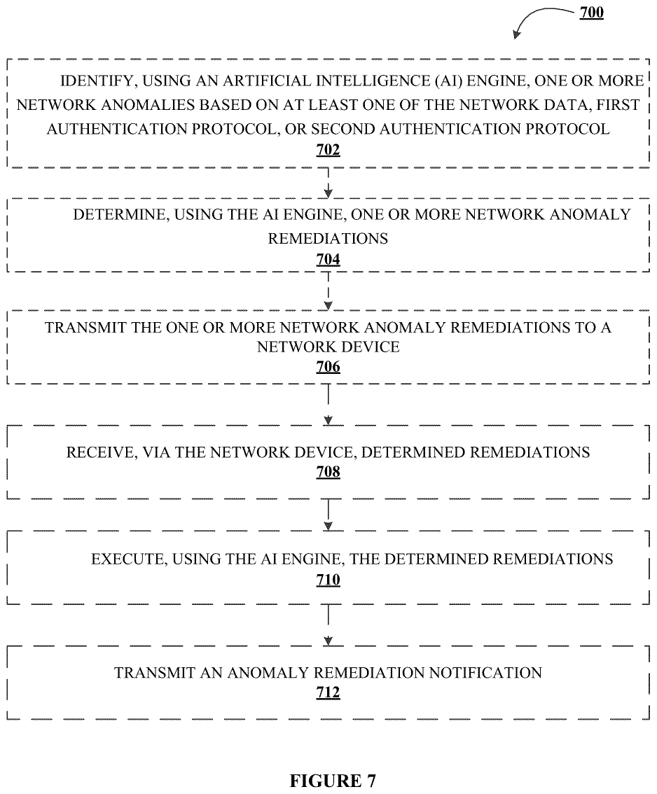

FIG. 7 illustrates a process flow 700 for determining network anomalies and network anomaly remediations using the AI engine, in accordance with an embodiment of the disclosure. In some embodiments, a system (e.g., similar to one or more of the systems described herein with respect to FIGS. 1A-1C) may perform one or more of the steps of process flow 700. For example, a multi-layer secure authentication engine for digital network security system (e.g., the system 130 described herein with respect to FIGS. 1A-1C) may perform the steps of process flow 700. In some embodiments, an AI engine (e.g., such as the AI engine like that described in FIG. 2) or a DLT architecture (e.g., such as the DLT architecture described in FIG. 3) may perform some or all of the steps described in process flow 700.

As shown in block 702, the process flow 700 may include the step of identifying, using an artificial intelligence (AI) engine, one or more network anomalies based on at least one of the network data, first authentication protocol, or second authentication protocol. In some embodiments, the one or network anomalies may comprise abnormal network traffic patterns transmitted between known network node agents, network traffic transmitted via unknown network node agents and/or network devices, unauthenticated access by an external network device, first authentication protocol anomaly, second authentication protocol anomaly, one or more digital network requests from restricted IP addresses, one or more digital network requests from restricted geographic locations, lack of access control criteria, failure to meet semantic thresholds, network data packets comprising compromised data and/or code, unpatched software, and/or the like.

In some embodiments, the AI engine may execute a network scan to identify network anomalies, wherein the network scan may comprise an internal vulnerability scan, external vulnerability scan, full-assessment scan, and/or penetration test, according to some embodiments. In some embodiments, the network scan may comprise at least one subnet of one network associated with the one or more digital network requests, one or more predetermined subnets of one or more networks associated with the one or more digital network requests, and/or the like. According to some embodiments, AI engine may log the one or more network anomalies, performance errors, latencies, and/or the like while executing the network scan. The AI engine may execute a network scan continuously, dynamically upon a triggering event, via user request, and/or at set intervals.

As shown in block 704, the process flow 700 may include the step of determining, using the AI engine, one or more network anomaly remediations. The AI engine may determine the one or more network anomaly remediations continuously, dynamically upon a triggering event (such as detecting a network anomaly), via user request, and/or at set intervals. The one or more network anomaly remediations may be determined based on the one or more digital network requests, first authentication protocol, second authentication protocol, first authentication protocol anomaly, second authentication protocol anomaly, network node validation, network node validation criteria, network data, and/or network node validation domain. In some embodiments, the one or more network anomaly remediations comprise responsive actions to mitigate the security threats caused by the one or more network anomalies. Responsive actions may comprise shutting down a network edge associated with the network anomaly, shutting down a network, restricting intra-network and/or inter-network transmissions, partitioning at least one network into subnets for revising network traffic flow, shutting down network ports, opening additional network ports, requiring re-authenticating and re-authorizing access of a user and/or network device and/or any network node agent, revoking authorization, revoking access, implementing additional authorization and/or authentication requirements (e.g., multifactor authentication), increasing security requirements, updating software to implement security patches, executing maintenance, splitting nodes from a network node chain, splicing blocks from a distributed ledger, and/or the like.

As shown in block 706, the process flow 700 may include the step of transmitting the one or more network anomaly remediations to a network device. In some embodiments, the MLSA engine, AI engine, and/or system may transmit the one or more network anomaly remediations to a network device, to the first network node agent, second network node agent, third network node agent, user device, and/or network device. In some embodiments, the one or more network anomaly remediations may comprise transmitting network data packets, text message, email, instant message, audio transmissions, video transmissions, alert via user interface, and/or push notification to a mobile device. According to some embodiments, the one or more network anomaly remediations may be transmitted via communication channel and/or via ETL and/or file transfer protocol, may comprise end-to-end encryption, a secure socket layer, transport layer security, and/or the like.

As shown in block 708, the process flow 700 may include the step of receiving, via the network device, determined remediations. In some embodiments, the determined remediations may comprise the one or more network anomaly remediations and/or an alternate set of network anomaly remediations. In some embodiments, the AI engine may select the determined remediations automatically in real-time based upon the network anomaly remediations, predetermined remediation actions, and/or input via network devices and/or user devices. According to some embodiments, the one or more network anomaly remediations may be rendered upon an interface for interactive activity by a user. A user may select control buttons associated with the one or more network anomaly remediations and/or the alternate set of network remediations, wherein the control buttons (e.g., approve, reject, modify, and/or the like), upon selection, may comprise the determined remediations. The determined remediations may be transmitted to the MLSA engine, AI engine, any network node agent, and/or network device.

As shown in block 710, the process flow 700 may include the step of executing, using the AI engine, the determined remediations. In some embodiments, executing the determined remediations comprises executing responsive actions associated with the determined remediations. Executing the determined remediations may occur dynamically upon selection, in real-time upon a trigger, and/or at set intervals, according to some embodiments. In some embodiments, the AI engine may log the success or failure of the determined remediations in mitigating the network anomaly, determine additional network anomaly remediations if the determined remediations fails and/or is disrupted, and/or the like.

As shown in block 712, the process flow 700 may include the step of transmitting an anomaly remediation notification. In some embodiments, the MLSA engine, AI engine, and/or system may generate and/or transmit the anomaly remediation notification to a network node agent, user device, and/or network device. In some embodiments, the anomaly remediation notification may comprise transmitting network data packets, text message, email, instant message, audio transmissions, video transmissions, alert via user interface, and/or push notification to a mobile device. According to some embodiments, the anomaly remediation notification may be transmitted via communication channel, may comprise end-to-end encryption, a secure socket layer, transport layer security, and/or the like.

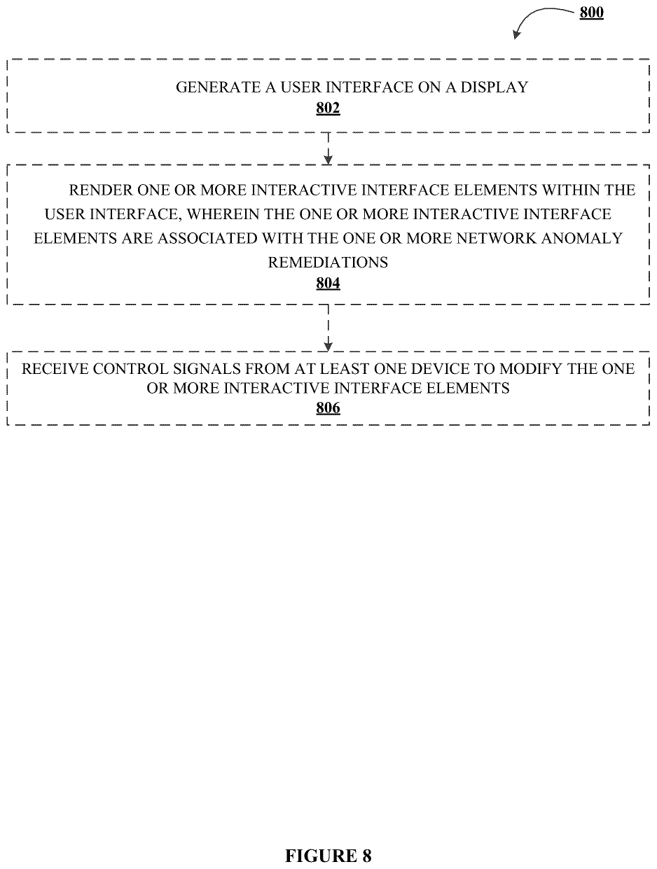

FIG. 8 illustrates a process flow 800 for generating a user interface and rendering interactive interface elements, in accordance with an embodiment of the disclosure. In some embodiments, a system (e.g., similar to one or more of the systems described herein with respect to FIGS. 1A-1C) may perform one or more of the steps of process flow 800. For example, a multi-layer secure authentication engine for digital network security system (e.g., the system 130 described herein with respect to FIGS. 1A-1C) may perform the steps of process flow 800. In some embodiments, an AI engine (e.g., such as the AI engine like that described in FIG. 2) or a DLT architecture (e.g., such as the DLT architecture described in FIG. 3) may perform some or all of the steps described in process flow 800.

As shown in block 802, the process flow 800 may include the step of generating a user interface on a display. According to some embodiments, the user interface may be disposed within a display device, mixed reality headset, projector system, mobile device, glasses, and/or the like. The user interface may comprise input devices and output devices, including without limitation physical buttons, capacitive touch buttons, digital icons and buttons, audio transmitter, audio receiver, microphone, speaker, and/or headphones, according to some embodiments.

As shown in block 804, the process flow 800 may include the step of rendering one or more interactive interface elements within the user interface, wherein the one or more interactive interface elements are associated with the one or more network anomaly remediations. According to some embodiments, the one or more interactive interface elements may comprise menus, channels associated with the determined network channel, icons, digital buttons, dashboards associated with the one or more network anomaly remediations, digital objects, and/or the like. The one or more interactive elements may activate upon selection, interaction, and/or input from the user, according to some embodiments. In some embodiments, the one or more interactive interface elements within the user interface may comprise the one or more network node chain graphs, wherein a user may manipulate the one or more interactive interface elements to evaluate network anomalies, analyze network traffic flows, and adjust views associated with the one or more interactive interface elements.

As shown in block 806, the process flow 800 may include the step of receiving control signals from at least one device to modify the one or more interactive interface elements. According to some embodiments, the control signals may be associated with input devices, mobile device, one or more network devices, the interactive interface elements, microphone, audio transmitter, and/or the like. By way of non-limiting example, and in some embodiments, a user may interact with the one or more interactive interface elements, which may generate control signals. According to some embodiments, the control signals may be associated with the determined remediations, one or more network anomaly remediations, one or more digital network requests, network transmission resources, first network node chain, target network node chain, and/or one or more network node chain graphs.

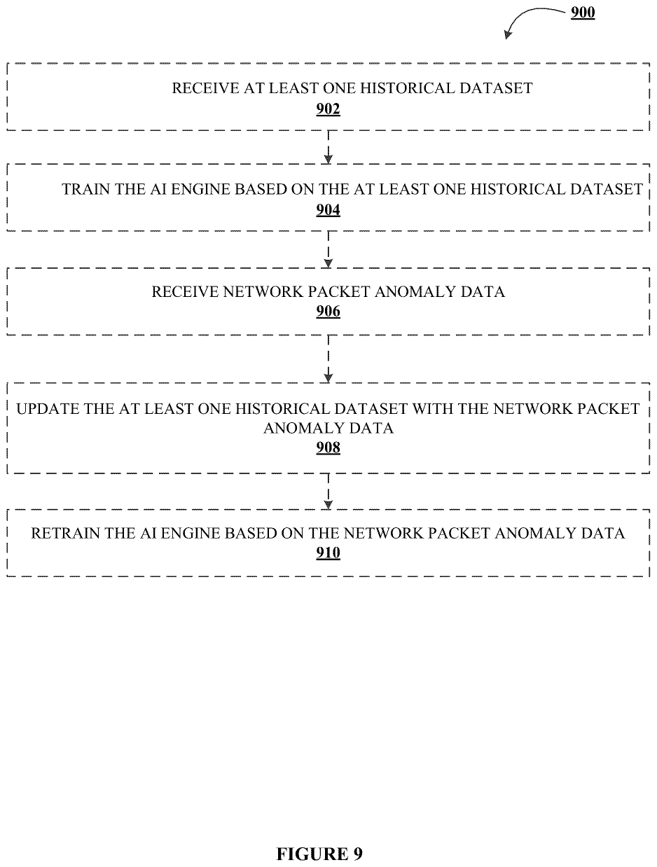

FIG. 9 illustrates a process flow 900 for training and retraining the AI engine, in accordance with an embodiment of the disclosure. In some embodiments, a system (e.g., similar to one or more of the systems described herein with respect to FIGS. 1A-1C) may perform one or more of the steps of process flow 900. For example, a multi-layer secure authentication engine for digital network security system (e.g., the system 130 described herein with respect to FIGS. 1A-1C) may perform the steps of process flow 900. In some embodiments, an AI engine (e.g., such as the AI engine like that described in FIG. 2) or a DLT architecture (e.g., such as the DLT architecture described in FIG. 3) may perform some or all of the steps described in process flow 900.

As shown in block 902, the process flow 900 may include the step of receiving at least one historical dataset. The at least one historical dataset may be stored in an internal data repository, hosted externally by an external network administrator, and/or the like. In some embodiments, the system may collect, compile, and/or aggregate historical data to create the at least one historical dataset and may store the at least one historical dataset in an internal data repository. In such a configuration, the system may access and retrieve the at least one historical dataset each time the AI engine may be trained. In some embodiments, the system may receive the at least one historical dataset continuously, at set internals, and/or via on-demand request generated by the dynamic engine, a user, a dynamic engine training controller, network device, and/or the like. In some embodiments, the system may receive the entire at least one historical dataset. According to sone embodiments, the system may only receive a subset of data contained within the at least one historical dataset based on training requirements associated with a dynamic engine training request generated by the system, user, network device, and/or the like. By training the dynamic engine on only a subset of the at least one historical dataset based on the most material and/or relevant data, the system may conserve computing resources, minimize energy expenditures, and/or enhance the dynamic engine performance. In some embodiments, the subset of data may not comprise sensitive data, preventing the inclusion of sensitive data in training the dynamic engine, which enhances data security and privacy.

As shown in block 904, the process flow 900 may include the step of training the AI engine based on the at least one historical dataset. In some embodiments, the at least one historical dataset comprises historical network data, historical one or more digital network requests, historical one or more network accounts, historical network validation domains, historical first authentical protocols, historical second authentication protocols, historical first encrypted self-executing programs, historical second encrypted self-executing programs, historical first encrypted self-executing program datasets, historical second encrypted self-executing program datasets, historical one or more network node chain graphs, historical one or more network anomaly remediations, historical determined remediations, and/or the like. In some embodiments the AI engine may comprise a generative AI model, in which training the generative AI model may comprise ingesting the historical dataset, adjusting parameters in response to generative AI model output, evaluating the model for fine-tuning, and/or deploying the generative AI model.

As shown in block 906, the process flow 900 may include the step of receiving network packet anomaly data. In some embodiments, receiving the network packet anomaly data may comprise receiving network data packets comprising network packet anomaly data. In some embodiments, a data aggregator may collect network packet anomaly data to generate aggregated network packet anomaly data and transmit the aggregated network packet anomaly data via network data packets to the system and/or dynamic engine. In some embodiments, the data aggregator may pre-process the network packet anomaly data, such as data cleansing, encrypting, and/or executing an ETL process. In some embodiments, the system may process the received network data packets, such as executing decryption, data extraction, and/or the like.

As shown in block 908, the process flow 900 may include the step of updating the at least one historical dataset with the network packet anomaly data. In some embodiments, the network packet anomaly data may be attached to the at least one historical dataset. In such a configuration, an ETL process may be executed to transmit the network packet anomaly data dataset to the same data storage repository as the at least one historical dataset.

As shown in block 910, the process flow 900 may include the step of retraining the AI engine based on the network packet anomaly data. The retraining step may be executed via feedback loop for continuous retraining and/or the retraining may occur via internal-based batch jobs, according to some embodiments. In some embodiments, the dynamic engine may refine itself by revising its weights and other such decision factors to improve accuracy, speed, and minimize errors, based on a dynamic engine training confidence threshold. In some embodiments, the system may determine the dynamic engine training confidence threshold, and if the dynamic engine training confidence threshold is below a given confidence threshold (e.g., predetermined, determined via notification from a network device, and/or dynamically determined by the system), the system may trigger retraining of the dynamic engine. In some embodiments, if criteria (e.g., one or more network anomalies, forecast network anomalies, one or more distributed network data domains, revised one or more distributed network data domains, network attribute set, revised network attribute set, and/or the like) and/or network packet anomaly data are generated and/or received by the system and/or dynamic engine (hereinafter referred to as “new training factors”), then the system and/or dynamic engine may trigger in real-time retraining of the dynamic engine based on the new training factors. By constantly monitoring for new training factors and triggering a responsive real-time retraining, the system provides a technical solution to the challenge of monitoring new training factors and changing network traffic conditions and adjusting the system dynamically.

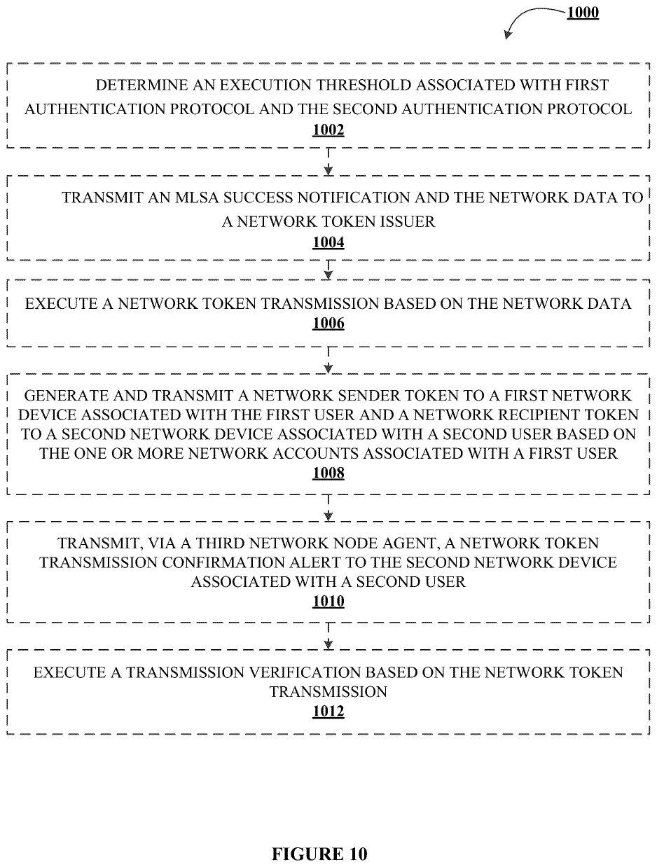

FIG. 10 illustrates a process flow 1000 for executing a network token transmission, in accordance with an embodiment of the disclosure. In some embodiments, a system (e.g., similar to one or more of the systems described herein with respect to FIGS. 1A-1C) may perform one or more of the steps of process flow 1000. For example, a multi-layer secure authentication engine for digital network security system (e.g., the system 130 described herein with respect to FIGS. 1A-1C) may perform the steps of process flow 1000. In some embodiments, an AI engine (e.g., such as the AI engine like that described in FIG. 2) or a DLT architecture (e.g., such as the DLT architecture described in FIG. 3) may perform some or all of the steps described in process flow 1000.

As shown in block 1002, the process flow 1000 may include the step of determining an execution threshold associated with first authentication protocol and the second authentication protocol. In some embodiments, the execution threshold associated with first authentication protocol and the second authentication protocol comprises confirming successful execution of both the first authentication protocol and the second authentication protocol. In some embodiments, the execution threshold may be determined by transmitting a first authentication protocol success confirmation message and a second authentication protocol success confirmation message to the first network node agent and/or second network node agent and receiving responsive network communications. In some embodiments, when the execution threshold is not met, the system initiates a halt to ongoing processes associated with the one or more digital network requests and transmits a failure message. The execution threshold may be determined by the MLSA engine, AI engine, and/or system after the first authentication protocol and the second authentication protocol completes, in some embodiments.

As shown in block 1004, the process flow 1000 may include the step of transmitting an MLSA success notification and the network data to a network token issuer. According to some embodiments. In some embodiments, the second network node agent, MLSA engine, AI engine, and/or system may transmit the MLSA success notification and the network data to the network token issuer. In some embodiments, the MLSA success notification is associated with the execution threshold and/or successful execution of the first authentication protocol and the second authentication protocol.

As shown in block 1006, the process flow 1000 may include the step of executing a network token transmission based on the network data. In some embodiments, the network token transmission may comprise network transmission resources, an identifier associated with the one or more network accounts, a recipient account identifier, a network token notification, tokens associated with the one or more digital network requests, and/or NFTs. In some embodiments, the network token transmission comprises network node block headers. The network token transmission may be executed immediately after transmission of the MLSA success notification and the network data to the network token issuer. In some embodiments, the network token issuer comprises a network node agent that issues tokens associated with digital network requests. In some embodiments, the network token transmission may comprise a transmission of network tokens from one or more network accounts associated with a first user to a network account associated with a second user.

As shown in block 1008, the process flow 1000 may include the step of generating and transmitting a network sender token to a first network device associated with the first user and a network recipient token to a second network device associated with a second user based on the one or more network accounts associated with a first user. According to some embodiments, the network sender token may comprise a deposit token associated with the first user and the network recipient token may comprise an issuer token associated with a second user.

As shown in block 1010, the process flow 1000 may include the step of transmitting, via a third network node agent, a network token transmission confirmation alert to the second network device associated with a second user. In some embodiments, the network token transmission confirmation alert comprises a success message associated with successful network token transmissions. In some embodiments, the MLSA engine, AI engine, and/or system may generate and/or transmit the network token transmission confirmation alert to the third network node agent, user device, and/or network device. In some embodiments, the network token transmission confirmation alert may comprise transmitting network data packets, text message, email, instant message, audio transmissions, video transmissions, alert via user interface, and/or push notification to a mobile device. According to some embodiments, the network token transmission confirmation alert may be transmitted via communication channel, may comprise end-to-end encryption, a secure socket layer, transport layer security, and/or the like.

As shown in block 1012, the process flow 1000 may include the step of executing a transmission verification based on the network token transmission. In some embodiments, the transmission verification may comprise validating successful completion of the network token transmission. According to some embodiments, the transmission verification may comprise comparing the network recipient token and the network sender token to predetermined thresholds and validating that the network recipient token and the network sender token contain no anomalies. In addition, the transmission verification may comprise that the network transmission resources successfully were transferred from the first user to the second user, according to some embodiments. In some embodiments, the transmission verification may comprise that each request within the one or more digital network requests has been processed (e.g., successfully executed, attempted to execute but an interception was initiated, and/or the like).

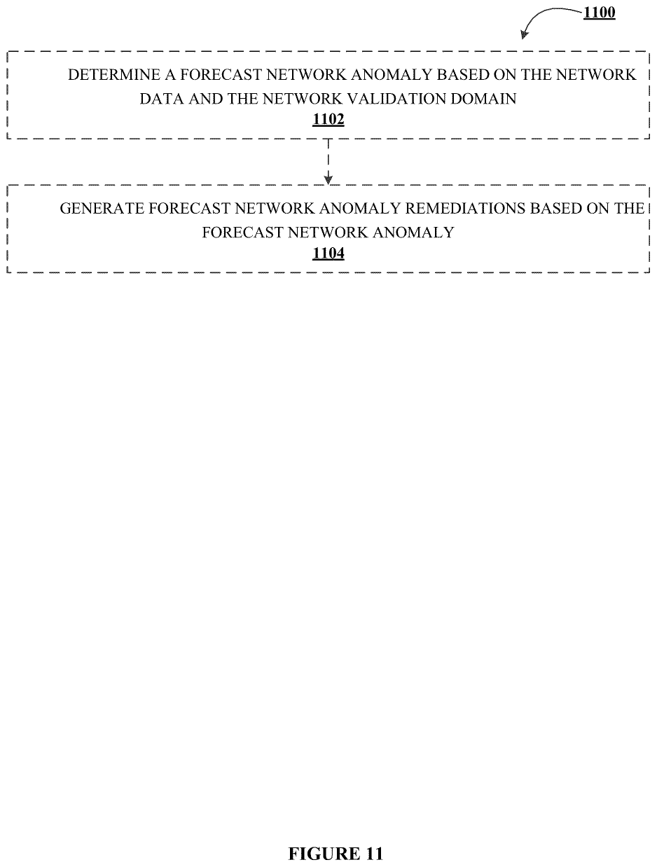

FIG. 11 illustrates a process flow 1100 for determining forecast network anomalies and generating forecast network anomaly remediations, in accordance with an embodiment of the disclosure. In some embodiments, a system (e.g., similar to one or more of the systems described herein with respect to FIGS. 1A-1C) may perform one or more of the steps of process flow 1100. For example, a multi-layer secure authentication engine for digital network security system (e.g., the system 130 described herein with respect to FIGS. 1A-1C) may perform the steps of process flow 1100. In some embodiments, an AI engine (e.g., such as the AI engine like that described in FIG. 2) or a DLT architecture (e.g., such as the DLT architecture described in FIG. 3) may perform some or all of the steps described in process flow 1100.

As shown in block 1102, the process flow 1100 may include the step of determining a forecast network anomaly based on the network data and the network validation domain. According to some embodiments, the AI engine may generate a forecast network anomaly using a forecasting model and/or a generative AI model. The AI engine may compare the network data, network validation domain, access control criteria, semantic threshold, first authentication protocol anomaly, second authentication protocol anomaly, and/or the one or more network anomalies to network data packets from continuous network traffic to determine a forecast network anomaly, in some embodiments. The forecast network anomaly may comprise emerging abnormal conditions based on emerging threats to the first network node chain and/or target network node chain. The AI engine may receive network analytics data from a plurality of sources and may analyze trends, abnormal patterns, suspicious activities, and/or the like in the network analytics data, according to some embodiments.

As shown in block 1104, the process flow 1100 may include the step of generating forecast network anomaly remediations based on the forecast network anomaly. The AI engine may generate the forecast network anomaly remediations to safeguard the first network node chain and/or target network node chain from forecast network anomalies. The forecast network anomaly remediations may comprise corrective actions to prevent network anomalies from penetrating and propagating throughout the first network node chain and/or target network node chain, in some embodiments. Examples of corrective responsive actions may comprise shutting down a network edge associated with the network anomaly, stopping network transmissions, freezing one or more digital network requests, shutting down a network gateway, restricting intra-network and/or inter-network transmissions, partitioning at least one network into subnets for revising network traffic flow, shutting down network ports, opening additional network ports, requiring re-authenticating and re-authorizing access of a user and/or network device and/or network node agent, revoking authorization, revoking access, implementing additional authorization and/or authentication requirements (e.g., multifactor authentication), increasing security requirements, updating software to implement security patches, executing maintenance, splitting nodes from a network node chain (such as first network node chain and/or target network node chain), splicing blocks from a distributed ledger, and/or the like, according to some embodiments.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for multi-layer secure authentication engine for digital network security, the system comprising:
a memory device with computer-readable program code stored thereon;
at least one processing device, wherein executing the computer-readable program code is configured to cause the at least one processing device to execute the computer-readable program code to:
receive and extract network data from one or more digital network
requests;
determine one or more network accounts associated with a first user based on the network data;
identify a network validation domain based on the network data;
transmit, via a first network node agent, the network data and the network
validation domain to a multi-layer secure authentication (MLSA) engine;
execute, via the MLSA engine, a first authentication protocol;
transmit the network data to a second network node agent; and
execute, via the MLSA engine, a second authentication protocol.

2. The system of claim 1, wherein the first authentication protocol comprises:
initiating a first encrypted self-executing program; determining, via the first encrypted self-executing program, access control criteria based on at least the network data, wherein the network data comprises a first network node chain, a target network node chain, and network transmission resources; generating one or more network node chain graphs based on at least one of the access control criteria, wherein the one or more network node chain graphs comprise a cross network chain control graph and a network data packet flow graph; and determining a semantic threshold based on the one or more network node chain graphs.

3. The system of claim 2, wherein executing the computer-readable program code is further configured to cause the at least one processing device to:
determine a first authentication protocol anomaly based on at least one of the access control criteria, one or more network node chain graphs, and semantic threshold;
intercept the one or more digital network requests; and
transmit a first authentication protocol anomaly notification to the first network node agent.

4. The system of claim 1, wherein the second authentication protocol comprises:
identifying network node validation criteria based on at least the network data, wherein the network data further comprises a second encrypted self-executing program dataset and a first encrypted self-executing program dataset; and executing a network node validation based on at least the network validation domain, wherein the network node validation comprises a relay network validation from each network node in at least one network node chain.

5. The system of claim 4, wherein executing the computer-readable program code is further configured to cause the at least one processing device to:
determine a second authentication protocol anomaly based on at least one of the network node validation and network node validation criteria;
intercept the one or more digital network requests; and
transmit a second authentication protocol anomaly notification to the first network node agent.

6. The system of claim 1, wherein executing the computer-readable program code is further configured to cause the at least one processing device to:
identify, using an artificial intelligence (AI) engine, one or more network anomalies based on at least one of the network data, first authentication protocol, or second authentication protocol;
determine, using the AI engine, one or more network anomaly remediations;
transmit the one or more network anomaly remediations to a network device;
receive, via the network device, determined remediations;
execute, using the AI engine, the determined remediations; and
transmit an anomaly remediation notification.

7. The system of claim 6, wherein executing the computer-readable program code is further configured to cause the at least one processing device to:
generate a user interface on a display;
render one or more interactive interface elements within the user interface, wherein the one or more interactive interface elements are associated with the one or more network anomaly remediations; and
receive control signals from at least one device to modify the one or more interactive interface elements.

8. The system of claim 6, wherein executing the computer-readable program code is further configured to cause the at least one processing device to:
receive at least one historical dataset;
train the AI engine based on the at least one historical dataset;
receive network packet anomaly data;
update the at least one historical dataset with the network packet anomaly data; and
retrain the AI engine based on the network packet anomaly data.

9. The system of claim 1, wherein executing the computer-readable program code is further configured to cause the at least one processing device to:
determine an execution threshold associated with first authentication protocol and the second authentication protocol;
transmit an MLSA success notification and the network data to a network token issuer;
execute a network token transmission based on the network data;
generate and transmit a network sender token to a first network device associated with the first user and a network recipient token to a second network device associated with a second user based on the one or more network accounts associated with a first user;
transmit, via a third network node agent, a network token transmission confirmation alert to the second network device associated with a second user; and
execute a transmission verification based on the network token transmission.

10. The system of claim 1, wherein executing the computer-readable program code is further configured to cause the at least one processing device to:
determine a forecast network anomaly based on the network data and the network validation domain; and
generate forecast network anomaly remediations based on the forecast network anomaly.

11. A computer program product for multi-layer secure authentication engine for digital network security, wherein the computer program product comprises at least one non-transitory computer-readable medium having computer-readable program code portion embodied therein, the computer-readable program code portions which when executed by a processing device are configured to cause a processor to:
receive and extract network data from one or more digital network requests;
determine one or more network accounts associated with a first user based on the network data;
identify a network validation domain based on the network data;
transmit, via a first network node agent, the network data and the network validation domain to a multi-layer secure authentication (MLSA) engine;
execute, via the MLSA engine, a first authentication protocol;
transmit the network data to a second network node agent; and
execute, via the MLSA engine, a second authentication protocol.

12. The computer program product of claim 11, wherein the first authentication protocol comprises:
initiating a first encrypted self-executing program; determining, via the first encrypted self-executing program, access control criteria based on at least the network data, wherein the network data comprises a first network node chain, a target network node chain, and network transmission resources; generating one or more network node chain graphs based on at least one of the access control criteria, wherein the one or more network node chain graphs comprise a cross network chain control graph and a network data packet flow graph; and determining a semantic threshold based on the one or more network node chain graphs.

13. The computer program product of claim 12, wherein the processing device is further configured to:
determine a first authentication protocol anomaly based on at least one of the access control criteria, one or more network node chain graphs, and semantic threshold;
intercept the one or more digital network requests; and
transmit a first authentication protocol anomaly notification to the first network node agent.

14. The computer program product of claim 11, wherein the second authentication protocol comprises:
identifying network node validation criteria based on at least the network data, wherein the network data further comprises a second encrypted self-executing program dataset and a first encrypted self-executing program dataset; and executing a network node validation based on at least the network validation domain, wherein the network node validation comprises a relay network validation from each network node in at least one network node chain.

15. The computer program product of claim 14, wherein the processing device is further configured to:
determine a second authentication protocol anomaly based on at least one of the network node validation and network node validation criteria;
intercept the one or more digital network requests; and
transmit a second authentication protocol anomaly notification to the first network node agent.

16. A computer-implemented method for multi-layer secure authentication engine for digital network security:
receiving and extracting network data from one or more digital network requests;
determining one or more network accounts associated with a first user based on the network data;
identifying a network validation domain based on the network data;
transmitting, via a first network node agent, the network data and the network validation domain to a multi-layer secure authentication (MLSA) engine;
executing, via the MLSA engine, a first authentication protocol;
transmitting the network data to a second network node agent; and
executing, via the MLSA engine, a second authentication protocol.

17. The computer-implemented method of claim 16, wherein the first authentication protocol comprises:
initiating a first encrypted self-executing program; determining, via the first encrypted self-executing program, access control criteria based on at least the network data, wherein the network data comprises a first network node chain, a target network node chain, and network transmission resources; generating one or more network node chain graphs based on at least one of the access control criteria, wherein the one or more network node chain graphs comprise a cross network chain control graph and a network data packet flow graph; and determining a semantic threshold based on the one or more network node chain graphs.

18. The computer-implemented method of claim 17, wherein the computer-implemented method is further configured for:
determining a first authentication protocol anomaly based on at least one of the access control criteria, one or more network node chain graphs, and semantic threshold;
intercepting the one or more digital network requests; and
transmitting a first authentication protocol anomaly notification to the first network node agent.

19. The computer-implemented method of claim 16, the second authentication protocol comprises:
identifying network node validation criteria based on at least the network data, wherein the network data further comprises a second encrypted self-executing program dataset and a first encrypted self-executing program dataset; and executing a network node validation based on at least the network validation domain, wherein the network node validation comprises a relay network validation from each network node in at least one network node chain.

20. The computer-implemented method of claim 19, wherein the computer-implemented method is further configured for:
determining a second authentication protocol anomaly based on at least one of the network node validation and network node validation criteria;
intercepting the one or more digital network requests; and
transmitting a second authentication protocol anomaly notification to the first network node agent.
